(19) United States
(12) Patent Application Publication
(10) Pub. No.: US 2026/0259535 A1
(43) Pub. Date: Sep. 3, 2026

(54) HOME APPLIANCE

(71) Applicant: LG ELECTRONICS INC., Seoul (KR)

(72) Inventors: Yongbong CHOI, Seoul (KR); Hyojun IM, Seoul (KR); Jiho LEE, Seoul (KR); Woogon SHIM, Seoul (KR); Youndong PARK, Seoul (KR); Jinbok LEE, Seoul (KR); Yonggyung BAE, Seoul (KR)

(73) Assignee: LG ELECTRONICS INC., Seoul (KR)

(21) Appl. No.: 18/877,581

(22) PCT Filed: Jun. 21, 2022
(86) PCT No.: PCT/KR2022/008752

§ 371 Date: Dec. 20, 2024

(51) Int. Cl. G05B 15/02; G05B 9/02; G06F 8/65

(52) U.S. Cl. CPC G05B 15/02; G05B 9/02; G06F 8/65

(57) ABSTRACT

A home appliance is disclosed. The home appliance of the present disclosure includes a circuit device including a first processor, wherein the first processor comprises a first core for load control or safety control, and a second core configured to control an operation mode based on an operating system, and perform an upgrade based on upgrade information received from an external server or a mobile terminal. Accordingly, the upgrade of the operation mode can be efficiently performed by separating the load control and the operation mode control.

### BACKGROUND OF THE DISCLOSURE

### 1. Field of the disclosure

This disclosure relates to a home appliance, and more particularly, to a home appliance capable of efficiently performing an upgrade of an operation mode by separating load control and operation mode control.

### 2. Description of the Related Art

A home appliance may be an electric device used in a home, such as a washing machine, a refrigerator, and an air conditioner.

As the functions of home appliance are advanced, various functions are being added to the home appliance. To this end, a function of downloading data from an external server or the like and updating the data is required.

However, since updates of load control data, safety control data, firmware data, application data, etc. are performed through a core in the same processor in the home appliance, there is disadvantage in that an efficient update cannot be performed. In addition, there is a disadvantage in that it is difficult to perform an upgrade of a new function.

### SUMMARY

The disclosure has been made in view of the above problems, and may provide a home appliance capable of efficiently performing an upgrade of an operation mode by separating load control and operation mode control.

Meanwhile, the disclosure may further provide a home appliance capable of efficiently performing firmware update or operation mode upgrade by separating a load control driven based on firmware and an operating mode control executed based on an operating system.

Meanwhile, the disclosure may further provide a home appliance capable of operating various types of home appliances based on a common platform.

Meanwhile, the disclosure may further provide a home appliance capable of efficiently performing an update or upgrade by applying a common platform to the home appliance.

In accordance with an aspect of the present disclosure, a home appliance includes a circuit device including a first processor, wherein the first processor comprises a first core for load control or safety control, and a second core configured to control an operation mode based on an operating system, and perform an upgrade based on upgrade information received from an external server or a mobile terminal.

Meanwhile, the home appliance according to an embodiment of the present disclosure may further include a second circuit including a second processor configured to control a light emitting diode or a display.

Meanwhile, the second core of the first processor is configured to execute the operating system, execute a framework on the operating system, and execute a system application, an application related to the operation mode, or a download application on the framework.

Meanwhile, a part of the operating system and the framework may correspond to a common platform.

Meanwhile, another part of the framework, the system application, the application related to the operation mode, and the download application may correspond to a variable platform.

Meanwhile, the operating system may be executed in common in other types of home appliances.

Meanwhile, the operating system or framework may be updated based on the firmware update information received from the server or the mobile terminal, and the system application, the application related to the operation mode, and the download application may be updated based on software update information received from the server or the mobile terminal.

Meanwhile, the update information is received from the external server or the mobile terminal, and a reception interval of software update information may be shorter than a reception interval of firmware update information received from the server or the mobile terminal.

Meanwhile, the software update interval of the circuit device may be shorter than the firmware update interval of the circuit device.

Meanwhile, the circuit device may be updated based on firmware update information received from the server or the mobile terminal, and the circuit device may be updated based on the firmware update information or software update information received from the server or the mobile terminal.

Meanwhile, the first processor may be configured to perform the update of the operating system and the update of the firmware independently.

Meanwhile, when the update data of the operating system and the firmware update data are received, the firmware of the first circuit may be updated after the operating system is updated.

Meanwhile, the first processor may be configured to output an inverter control signal or an inverter command signal for load control.

Meanwhile, the circuit device may be configured to perform a remote procedure call communication with the second circuit.

Meanwhile, the first processor be configured to perform a remote procedure call communication with the second processor.

Meanwhile, the circuit device may further include a transceiver configured to perform wireless communication with the server or the mobile terminal.

Meanwhile, the circuit device may further include a memory configured to store firmware for load control or safety control in a first area, and store the operating system in a second area.

Meanwhile, when the transceiver receives firmware update information from the server or the mobile terminal, the second core in the first processor may transmit the firmware update information to the memory of the circuit device, and the memory of the circuit device may be configured to update the firmware based on the firmware update information.

Meanwhile, the memory of the circuit device may be configured to not update the firmware during the operation mode, but update the firmware after the operation mode is terminated.

Meanwhile, when the transceiver receives software update information from the server or the mobile terminal, the second core of the first processor may be configured to transmit the software update information to the memory of the circuit device, and the memory of the circuit device may be configured to update an application, based on the software update information.

Meanwhile, the memory of the circuit device may be configured to update application excluding the operating system and the framework, among software, during the operation mode.

Meanwhile, the memory of the circuit device may be configured to update the operating system or the framework, after the operation mode is terminated, without updating the operating system or the framework, during the operation mode.

Meanwhile, in response to the home appliance being a first product, the second core in the first processor may be configured to execute an operating system, execute a common framework in a part on the operating system, execute a first product framework in another part on the operating system, and execute a first product-related application on the common framework and the first product framework.

Meanwhile, in response to the home appliance being a second product, the second core in the first processor may be configured to execute the operating system, execute a common framework in a part on the operating system, execute a second product framework in another part on the operating system, and execute a second product-related application on the common framework and the second product framework.

Meanwhile, the second core in the first processor may be configured to update the first product-related application, during operation of the first product.

Meanwhile, the second core in the first processor may be configured to update the operating system or the common framework, after the operation of the first product is terminated.

Meanwhile, the processing speed of the second core in the first processor may be faster than the processing speed of the first core in the first processor.

In accordance with another aspect of the present disclosure, a home appliance includes a circuit device including a first processor, wherein the first processor comprises a first core for load control or safety control, and a second core configured to control an operation mode based on an operating system, and perform an application update during operation mode based on application update information received from an external server or a mobile terminal.

Meanwhile, when receiving display theme-related update information from the server or the mobile terminal, the second core of the first processor may be configured to display a first display theme at a first time point, perform an update based on the display theme-related update information during operation mode, and display a second display theme corresponding to the display theme-related update information, at a second time point after the first time point.

Meanwhile, when receiving firmware update information from the server or the mobile terminal, the second core of the first processor may be configured to perform a firmware update, after the operation mode is terminated.

Meanwhile, the home appliance according to another aspect of the present disclosure may further include a second circuit including a second processor for controlling a light emitting diode or a display.

Meanwhile, in accordance with another aspect of the present disclosure, a home appliance includes a circuit device including a processor configured to execute a first virtual machine for load control or safety control, wherein the processor is further configured to execute a second virtual machine to control an operation mode based on an operating system, and perform an upgrade based on upgrade information received from an external server or a mobile terminal.

Meanwhile, the first virtual machine is configured to execute the load control or safety control based on firmware, and the second virtual machine is configured to control the operation mode based on the operating system, and perform an application update during the operation mode based on application update information received from the external server or mobile terminal.

### EFFECTS OF THE DISCLOSURE

A home appliance according to an embodiment of the present disclosure includes a circuit device including a first processor, wherein the first processor comprises a first core for load control or safety control, and second core configured to control an operation mode based on an operating system, and perform an upgrade based on upgrade. Accordingly, the upgrade of the operation mode can be performed efficiently by separating the load control and the operation mode control. Specifically, the upgrade of the operation mode can be performed efficiently by separating the load control driven based on the firmware and the operation mode control executed based on the operating system. In addition, the operating system executed on the second core in the first processor may be updated.

Meanwhile, the home appliance according to an embodiment of the present disclosure may further include a second circuit including a second processor configured to control a light emitting diode or a display. Accordingly, the light emitting diode or the display can be controlled through a separate second circuit.

Meanwhile, the second core in the first processor may be configured to execute the operating system, execute a framework on the operating system, and execute a system application, an application related to the operation mode, or a download application on the framework. Accordingly, the update of the framework or the application can be performed easily and efficiently based on the operating system.

Meanwhile, a part of the operating system and the framework may correspond to a common platform. Accordingly, various types of home appliances can be operated based on a common platform. In addition, the update or upgrade can be performed efficiently by applying a common platform to the home appliances.

Meanwhile, another part of the framework, the system application, the application related to the operation mode, and the download application may correspond to a variable platform. Accordingly, the update of the variable platform or the upgrade of the driving mode can be performed efficiently.

Meanwhile, the operating system may be executed in common in other types of home appliances. Accordingly, various types of home appliances can be operated based on a common platform.

Meanwhile, the operating system or framework may be updated based on the firmware update information received from the server or the mobile terminal, and the system application, the application related to the operation mode, and the download application may be updated or upgraded, based on software update information received from the server or the mobile terminal. Thus, the update or upgrade can be efficiently performed by Separating the firmware update and the software update.

Meanwhile, the update information is received from the external server or the mobile terminal, and a reception interval of software update information may be shorter than a reception interval of firmware update information received from the server or the mobile terminal. Accordingly, the software update can be performed frequently and simply.

Meanwhile, the software update interval of the circuit device may be shorter than the firmware update interval of the circuit device. Accordingly, the software update can be performed frequently and efficiently.

Meanwhile, the circuit device may be updated based on firmware update information received from the server or the mobile terminal, and the circuit device may be updated based on the firmware update information or software update information received from the server or the mobile terminal. Thus, the update of the firmware or the upgrade of the operation mode can be performed efficiently by separating the load control driven based on the firmware and the operation mode control executed based on the operating system.

Meanwhile, the first processor may be configured to perform the update of the operating system and the update of the firmware independently. Accordingly, the update of the operating system and the update of the firmware can be performed efficiently.

Meanwhile, when the update data of the operating system and the firmware update data are received, the firmware of the first circuit may be updated after the operating system is updated. Thus, the update of the firmware can be performed stably and efficiently by first performing the update of the operating system.

Meanwhile, the first processor may be configured to output an inverter control signal or an inverter command signal for load control. Accordingly, load control or safety control can be performed directly or indirectly by using the first processor separated from the second processor.

Meanwhile, the circuit device may be configured to perform a remote procedure call communication with the second circuit. Thus, a communication can be performed efficiently by using inter-processor communication (IPC).

Meanwhile, the first processor may be configured to perform remote procedure call communication with the second processor. Thus, a communication can be performed efficiently by using inter-processor communication (IPC).

Meanwhile, the circuit device may further include a transceiver configured to perform wireless communication with the server or the mobile terminal. Accordingly, external data may be received or data may be transmitted to the outside through the second circuit.

Meanwhile, the first circuit may further include a memory configured to store firmware for load control or safety control, and the second circuit may further include a memory configured to store the operating system. Thus, the update of the firmware or the upgrade of the operation mode can be performed efficiently by separating the load control driven based on the firmware and the operation mode control executed based on the operating system.

Meanwhile, when the transceiver receives firmware update information from the server or the mobile terminal, the second core in the first processor may transmit the firmware update information to the memory of the circuit device, and the memory of the circuit device may be configured to update the firmware based on the firmware update information. Accordingly, the firmware update can be efficiently performed.

Meanwhile, the memory of the circuit device may be configured to update the firmware, after the operation mode is terminated without updating the firmware, during the operation mode. Accordingly, the firmware update may be performed stably.

Meanwhile, when the transceiver receives software update information from the server or the mobile terminal, the second core of the first processor may be configured to transmit the software update information to the memory of the circuit device, and the memory of the circuit device may be configured to update the application, based on the software update information. Accordingly, the software update may be performed efficiently.

Meanwhile, the memory of the circuit device may be configured to update the application, excluding the operating system and framework among the software during the operation mode. Accordingly, the application update can be performed immediately.

Meanwhile, the memory in the circuit device may be configured to update the operating system or framework, after the operation mode is terminated, without updating the operating system or framework, during the operation mode. Accordingly, the operating system or framework can be updated stably.

Meanwhile, in response to the home appliance being a first product, the second core in the first processor may be configured to execute an operating system, execute a common framework in a part on the operating system, execute a first product framework in another part on the operating system, and execute a first product-related application on the common framework and the first product framework. Accordingly, the first product can be operated based on the common platform.

Meanwhile, in response to the home appliance being a second product, the second core in the first processor may be configured to execute the operating system, execute a common framework in a part on the operating system, execute a second product framework in another part on the operating system, and execute a second product-related application on the common framework and the second product framework. Accordingly, the second product can be operated based on the common platform.

Meanwhile, the second core in the first processor may be configured to update the first product-related application, during operation of the first product. Accordingly, the update of the first product-related application can be immediately performed.

Meanwhile, the second core in the first processor may be configured to update the operating system or the common framework, after the operation of the first product is terminated. Accordingly, the update of the operating system or the common framework in the first product can be performed stably.

Meanwhile, the processing speed of the second core in the first processor may be faster than the processing speed of the first core in the first processor. Accordingly, the operation mode control executed based on the operating system can be efficiently performed.

In accordance with another aspect of the present disclosure, a home appliance may include a circuit device including a first processor, wherein the first processor comprises a first core for load control or safety control, and a second core configured to control an operation mode based on an operating system, and perform application update during the operation mode based on application update information received from an external server or a mobile terminal. Accordingly, the update can be efficiently performed by separating the load control and the operation mode control. In particular, an application update can be performed immediately.

Meanwhile, when receiving display theme-related update information from the server or the mobile terminal, the second core in the first processor may be configured to display a first display theme at a first time point, perform an update based on the display theme-related update information during operation mode, and display a second display theme corresponding to the display theme-related update information, at a second time point after the first time point. Accordingly, the update related to the display theme can be performed immediately.

Meanwhile, when receiving firmware update information from the server or the mobile terminal, the second core in the first processor may be configured to perform a firmware update, after the operation terminated. Accordingly, the firmware update can be performed stably.

Meanwhile, the home appliance according to another aspect of the present disclosure may further include a second circuit including a second processor configured control a light emitting diode or a display. Accordingly, the light emitting diode or the display can be controlled through a separate second circuit.

Meanwhile, in accordance with another aspect of the present disclosure, a home appliance includes a circuit device including a processor configured to execute a first virtual machine for load control or safety control, in which the processor is further configured to execute a second virtual machine to control an operation mode based on an operating system, and perform an upgrade based on upgrade information received from an external server or a mobile terminal. Accordingly, load control and operation mode control are separated to efficiently perform an upgrade for the operation mode. Specifically, load control driven based on firmware and operation mode control executed based on the operating system are separated to efficiently perform an operation mode upgrade. In addition, the operating system executed in a second virtual machine of the first processor may also be updated.

Meanwhile, the first virtual machine is configured to execute the load control or safety control based on firmware, and the second virtual machine is configured to control the operation mode based on the operating system, and perform an application update during the operation mode based on application update information received from the external server or mobile terminal. Accordingly, load control and operation mode control are separated to efficiently perform an update. In particular, application update can be performed immediately.

### BRIEF DESCRIPTION OF THE DRAWINGS

FIG. 1 is an example a configuration diagram of a home appliance system including a home appliance according to an embodiment of the present disclosure;

FIGS. 2A to 2D are diagrams illustrating various examples of the home appliance of FIG. 1;

FIG. 3 is an example of an internal block diagram of a mobile terminal of FIG. 1;

FIG. 4A is an example of an internal block diagram of a home appliance according to the present disclosure;

FIGS. 4B and 4C are diagrams for explaining FIG. 4A;

FIG. 5A is an example of an internal block diagram of a home appliance according to an embodiment of the present disclosure;

FIG. 5B is another example of an internal block diagram of a home appliance according to an embodiment of the present disclosure;

FIG. 5C is another example of an internal block diagram of a home appliance according to an embodiment of the present disclosure;

FIG. 5D is another example of an internal block diagram of a home appliance according to an embodiment of the present disclosure;

FIGS. 6A to 10D are diagrams for explaining the operation of the home appliance of FIG. 5A or 5B; and

FIG. 11 is a flowchart illustrating a method of operating a home appliance according to an embodiment of the present disclosure.

### DETAILED DESCRIPTION OF THE PREFERRED EMBODIMENTS

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the terms “module” and “unit” may be used interchangeably.

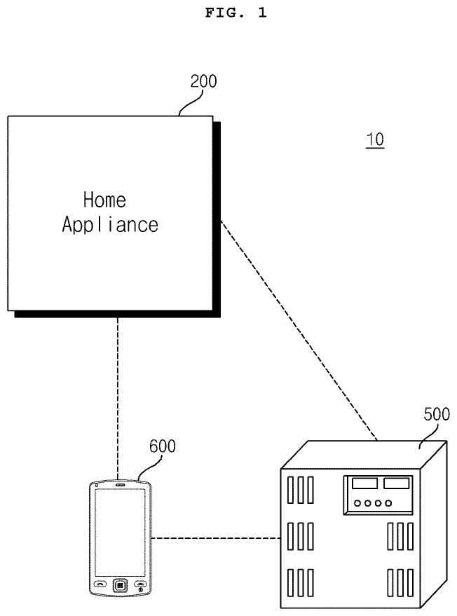

FIG. 1 is an example of a configuration diagram of a home appliance system including a home appliance according to an embodiment of the present disclosure.

Referring to FIG. 1, a home appliance system 10 according to an embodiment of the present disclosure may include a home appliance 200, the mobile terminal 600, and a server 500.

In addition, the home appliance system 10 may further include an access point (AP) device (not shown) for connecting the home appliance 200 to an external network.

The home appliance 200 includes a motor, a magnetron, or a heater for load control and the like.

Meanwhile, the home appliance 200 may include an inverter to convert DC power into AC power for efficient load control.

Meanwhile, the home appliance 200 may be configured to execute a system application, an application related to an operation mode, or a download application therein.

Meanwhile, the mobile terminal 600 may be configured to perform wireless communication with the home appliance 200 to remotely control the wirelessly connected home appliance 200, or to receive monitoring data from the home appliance 200.

Meanwhile, the server 500 may provide data to the home appliance 200 connected through a network or the like.

For example, the server 500 may provide update information to the home appliance 200 in response to a request of the mobile terminal 600.

As another example, the server 500 may provide update information to the home appliance 200 when necessary, even when there is no request from the mobile terminal 600 or the home appliance 200.

Meanwhile, the update information may include firmware update information, software update information, and the like.

The firmware update information is data for updating the firmware of the home appliance 200, and may be, for example, update information for load control or safety control of the home appliance 200.

Meanwhile, the software update information may include upgrade information related to a new operation mode. Based on the upgrade information related to the new operation mode, the operation mode may be upgraded.

Meanwhile, the software update information may further include update information on a system application, an application related to an operation mode, or a download application. Based on such update information, an update of the operation mode may be performed.

The firmware update information may include date data for firmware, an operating system, or a framework. Based on the firmware update information, the firmware may be updated.

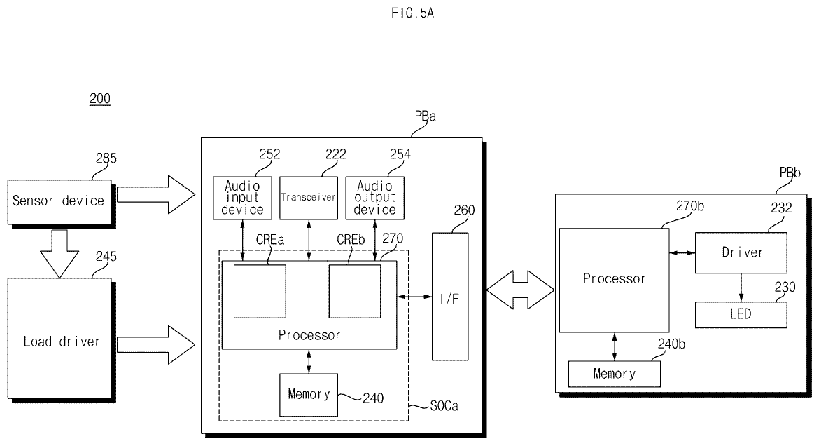

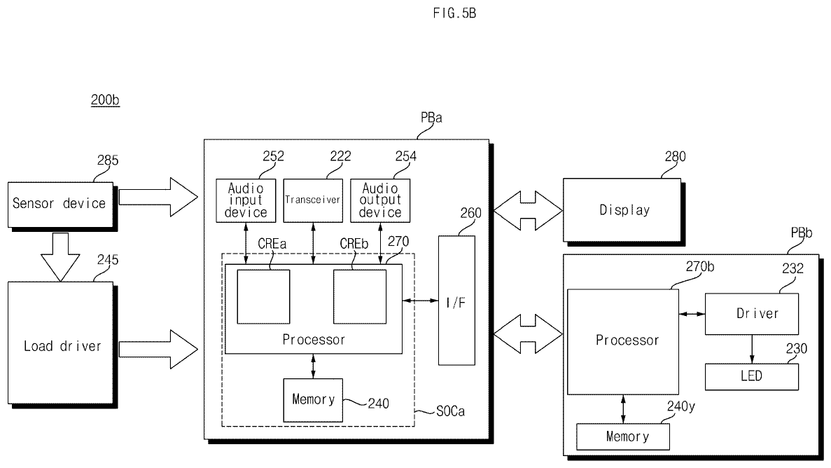

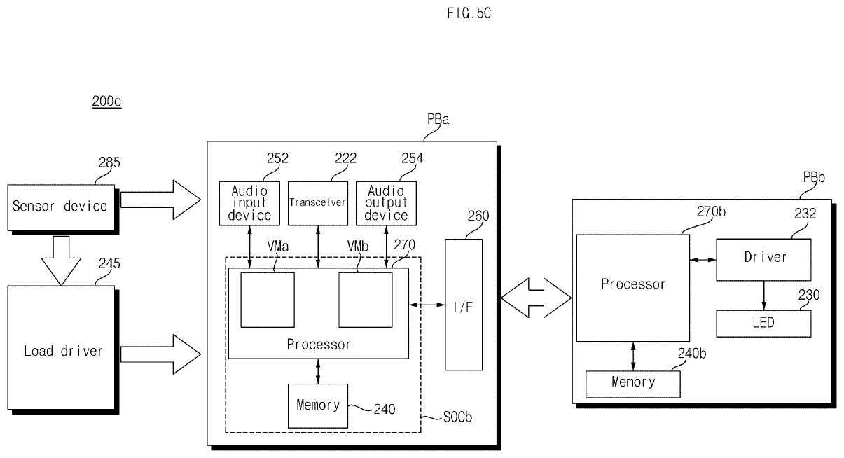

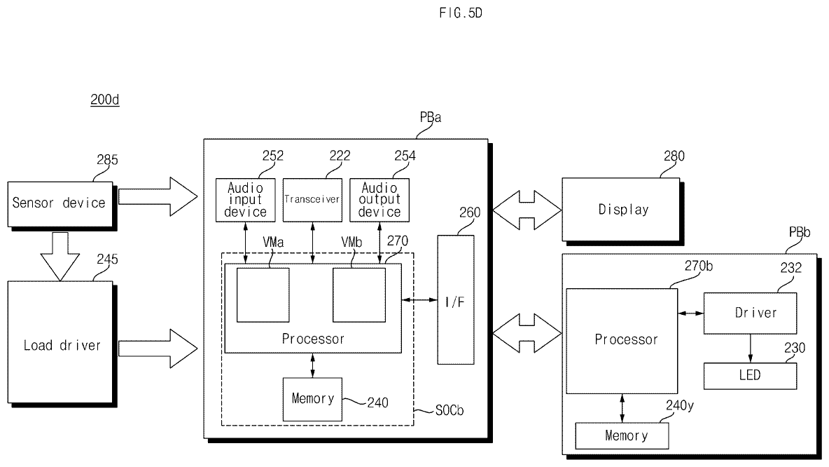

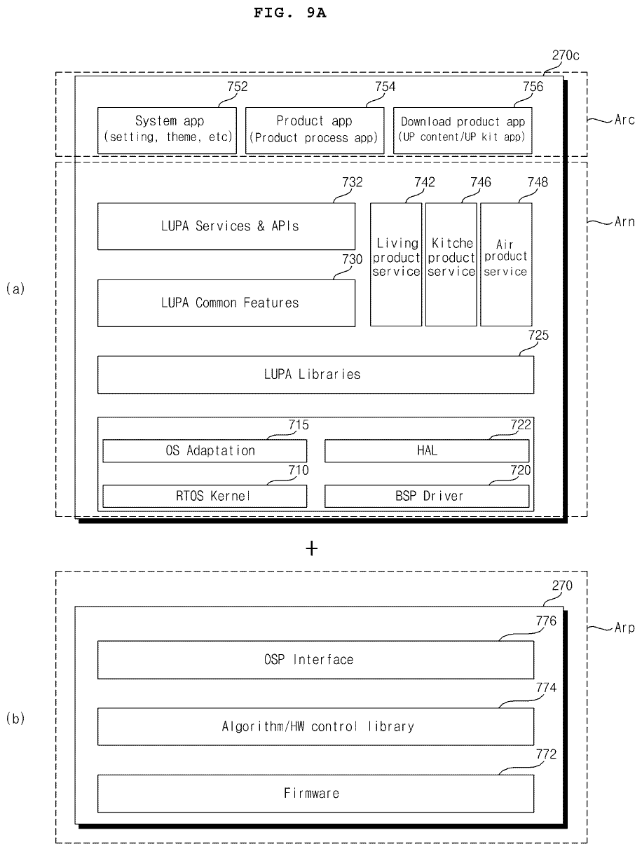

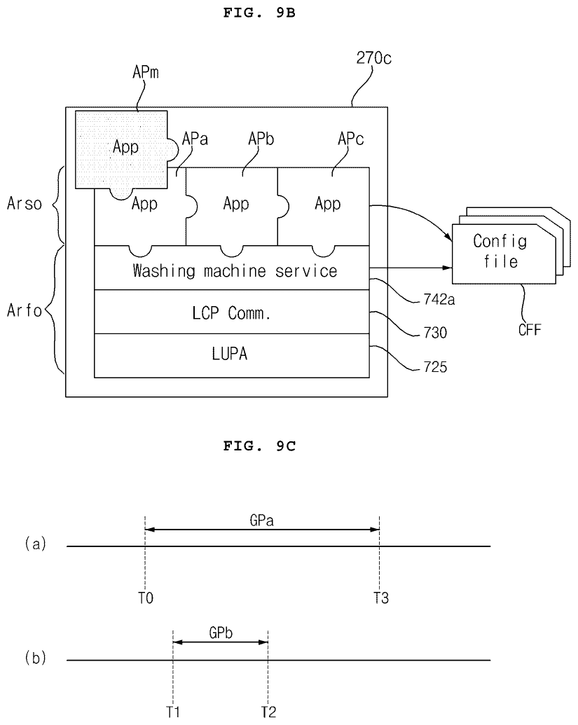

The home appliance 200 according to an embodiment of the present disclosure includes a circuit device (PBa in FIG. 5A) having a first core (CREa in FIG. 5A) of a first processor for load control or safety control, and a second core (CREb in FIG. 5A) of a first processor which controls the operation mode based on an operating system (710 in FIG. 7A), and is configured to perform an upgrade based on the upgrade information received from the external server 500 or the mobile terminal 600.

Accordingly, an upgrade for the operation mode may be efficiently accomplished by separating the load control and the operation mode control. Specifically, firmware update or operation mode upgrade may be efficiently accomplished by separating the load control driven based on the firmware and the operation mode control executed based on the operating system 710.

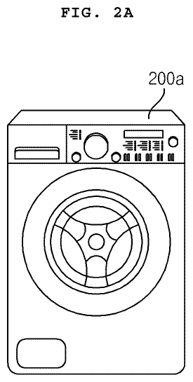

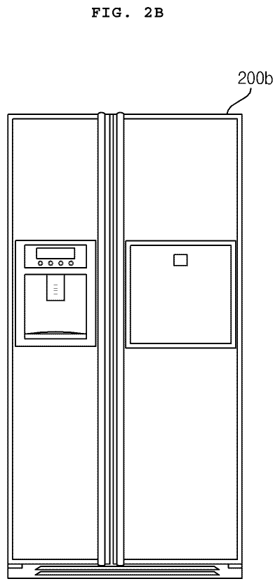

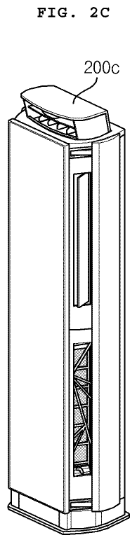

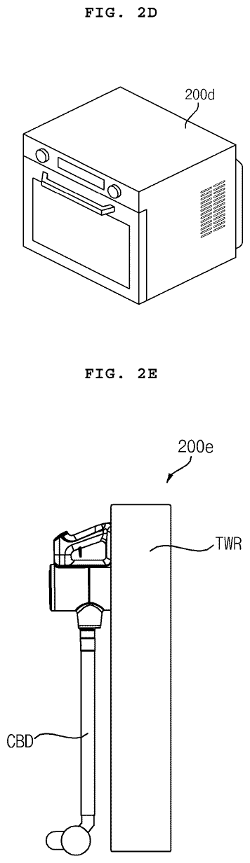

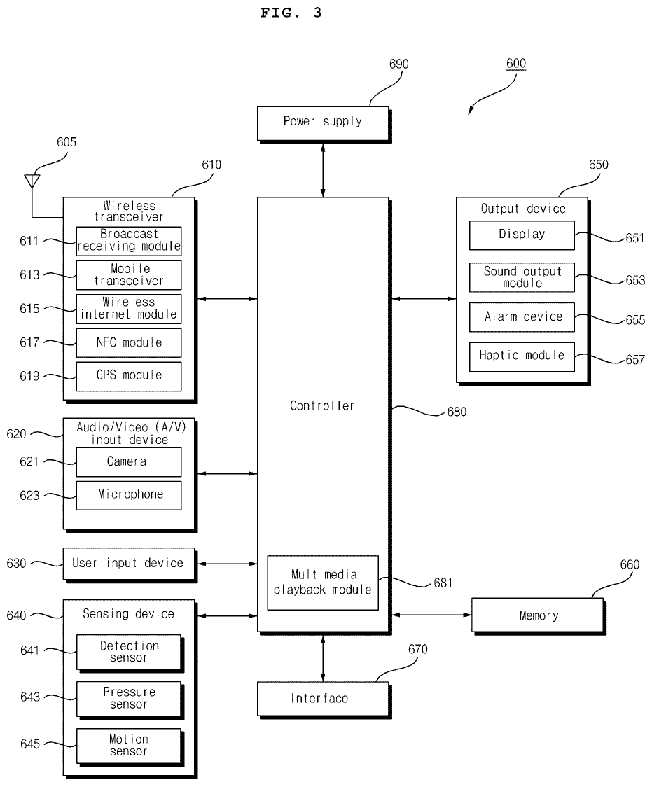

Meanwhile, various examples of the home appliance 200 applied in the present disclosure are possible. This is exemplified through FIGS. 2A to 2D.

FIGS. 2A to 2D are diagrams illustrating various examples of the home appliance of FIG. 1.

FIG. 2A illustrates a washing machine 200a as an example of a home appliance.

When the home appliance 200 is the washing machine 200a, the washing machine 200a may include a washing tub motor (not shown) and an inverter (not shown) for rotating the washing tub motor so as to rotate a washing tub.

FIG. 2B illustrates a refrigerator 200b as an example of a home appliance.

When the home appliance 200 is the refrigerator 200b, the refrigerator 200b may include a compressor (not shown), a compressor motor (not shown) for operation of the compressor, and an inverter (not shown) for controlling the compressor motor so as to supply cold air into the refrigerator.

FIG. 2C illustrates an air conditioner 200c as an example of a home appliance.

When the home appliance 200 is the air conditioner 200c, the air conditioner 200c may include a compressor (not shown), a compressor motor (not shown) for operation of the compressor, and an inverter (not shown) for controlling the compressor motor so as to supply cold air from the air conditioner.

FIG. 2D illustrates a cooking appliance 200d as an example of a home appliance.

When the home appliance 200 is the cooking appliance 200d, the cooking appliance 200d may include a magnetron (not shown) or a light wave heater (not shown) and an inverter (not shown) for controlling the magnetron or light wave heater so as to heat foods in the cooking appliance.

FIG. 2E illustrates a cleaner 200e as an example of a home appliance.

When the home appliance 200 is the cleaner 200e, the cleaner 200e may include a fan motor (not shown) and an inverter (not shown) for controlling the fan motor so as to suck foreign substances of the cooking appliance.

Meanwhile, according to an embodiment of the present disclosure, various examples of the home appliance 200 such as a washing machine 200a, a refrigerator 200b, an air conditioner 200c, a cooking appliance 200d, and a cleaner 200e, as well as a dryer, a clothes manager, a robot cleaner, and an air purifier, are possible.

FIG. 3 is an internal block diagram of the mobile terminal of FIG. 1.

Referring to FIG. 3, the mobile terminal 600 may include a wireless transceiver 610, an audio/video (A/V) input device 620, a user input device 630, a sensing device 640, an output device 650, a memory 660, an interface 670, a controller 680, and a power supply 690.

Meanwhile, the wireless transceiver 610 may include a broadcast receiving module 611, a mobile transceiver 613, a wireless Internet module 615, an NFC module 617, and a GPS module 619.

The broadcast receiving module 611 may receive at least one of a broadcast signal or broadcast related information from an external broadcast management server through a broadcast channel. In this case, the broadcast channel may include a satellite channel, a terrestrial channel, and the like.

The broadcast signal and/or broadcast related information received through the broadcast receiving module 611 may be stored in the memory 660.

The mobile transceiver 613 may transmit/receive a wireless signal to and from at least one of a base station, an external terminal, or a server on a mobile communication network. Here, the wireless signal may include a voice call signal, a video call signal, or various types of data according to text/multimedia message transmission/reception.

The wireless Internet module 615 refers to a module for wireless Internet access, and the wireless Internet module 615 may be built-in the mobile terminal 600 or may be externally provided to the mobile terminal. For example, the wireless Internet module 615 may be configured to perform WiFi-based wireless communication or WiFi Direct-based wireless communication.

The NFC module 617 may be configured to perform near field communication. The NFC module 617 may receive data from a corresponding home appliance or transmit data to the corresponding home appliance, when it approaches within a certain distance from a NFC tag or a home appliance in which the NFC module is mounted, that is, when tagging is performed.

In addition, Bluetooth, Radio Frequency Identification (RFID), infrared data association (IrDA), Ultra Wideband (UWB), ZigBee, and the like may be used as a short-range communication technology.

The Global Position System (GPS) module 619 may receive location information from a plurality of GPS satellites.

The Audio/Video (A/V) input device 620 is for inputting an audio signal or a video signal, and may include a camera 621, a microphone 623, and the like.

The user input device 630 generates key input data input by a user to control the operation of the terminal. To this end, the user input device 630 may include a key pad, a dome switch, a touch pad (pressure/capacitance), and the like. In particular, when the touch pad forms a mutual layer structure with the display 651, it may be referred to as a touch screen.

The sensing device 640 may generate a sensing signal for controlling the operation of the mobile terminal 600 by detecting the current state of the mobile terminal 600, such as the open/closed state of the mobile terminal 600, the location of the mobile terminal 600, and the contact of user.

The sensing device 640 may include a detection sensor 641, a pressure sensor 643, and a motion sensor 645. The motion sensor 645 may detect the movement or location of the mobile terminal 600 by using an acceleration sensor, a gyro sensor, a gravity sensor, or the like. In particular, the gyro sensor is a sensor for measuring angular velocity, and may detect a direction (angle) that is turned with respect to a reference direction.

The output device 650 may include a display 651, a sound output module 653, an alarm device 655, and a haptic module 657.

The display 651 displays and outputs information processed by the mobile terminal 600.

Meanwhile, as described above, when the display 651 and the touchpad form a mutual layer structure to configure a touch screen, the display 651 can also be used as an input device capable of inputting information by a user's touch in addition to the output device.

The sound output module 653 outputs audio data that is received from the wireless transceiver 610 or stored in the memory 660. Such a sound output module 653 may include a speaker, a buzzer, and the like.

The alarm device 655 outputs a signal for notifying the occurrence of an event in the mobile terminal 600. For example, the signal may be output in the form of vibration.

The haptic module 657 generates various tactile effects that a user can feel. A representative example of the tactile effect generated by the haptic module 657 is a vibration effect.

The memory 660 may store a program for processing and controlling the controller 680, and may serve to temporarily store the input or output data (e.g. phone book, message, still image, video, etc.).

The interface 670 may serve as an interface with all external devices connected to the mobile terminal 600. The interface 670 may receive data or receive power from such an external device and transmit it to each component of the mobile terminal 600, and may be configured to transmit the data of the mobile terminal 600 to an external device.

The controller 680 may generally control the overall operation of the mobile terminal 600 by controlling the operation of each of the above units. For example, it may be configured to perform related control and processing for voice call, data communication, video call, and the like. In addition, the controller 680 may include a multimedia playback module 681 for multimedia playback. The multimedia playback module 681 may be configured as hardware in the controller 680 or may be configured as software separately from the controller 680.

The power supply 690 may receive external power and internal power under the control of the controller 680 to supply power necessary for the operation of each component.

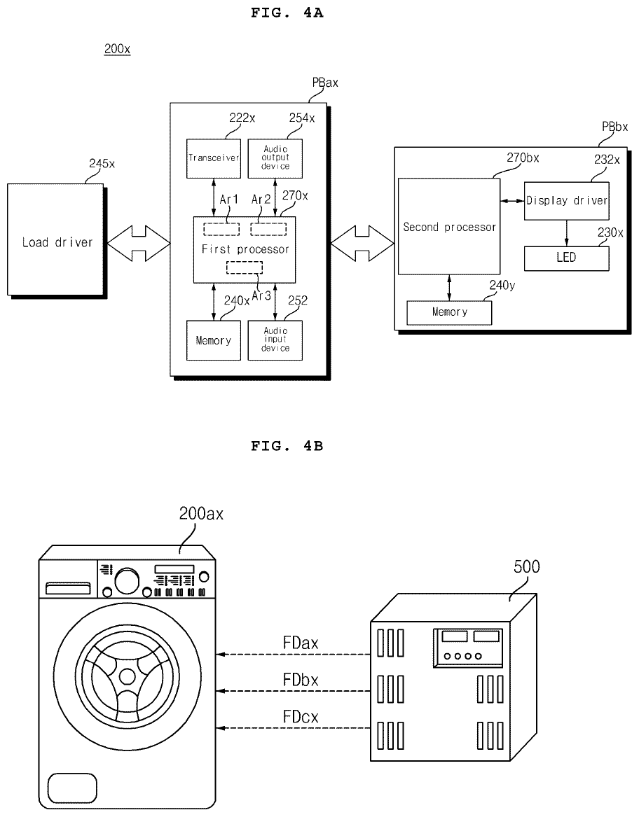

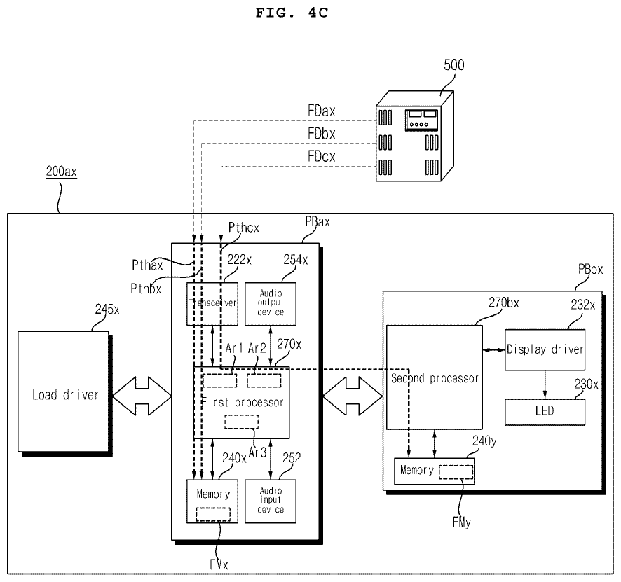

FIG. 4A is an example of an internal block diagram of a home appliance according to the present disclosure.

Referring to FIG. 4A, the home appliance 200x according to the present disclosure includes a first circuit device PBax for load control or safety control, and a second circuit PBbx for light emitting diode control.

Meanwhile, the first circuit device PBax may be configured to output a load control signal or a safety control signal to a load driver 245x that operates to drive a load such as a motor or a magnetron.

The first circuit device PBax may include a memory 240x for storing data related to a load control signal or a safety control signal, a first processor 270x for outputting the load control signal or the safety control signal, a transceiver 222x for performing communication with an external mobile terminal 600 or a server 500, an audio output device 254x for outputting audio, and an audio input device 252 for collecting audio.

Meanwhile, the second circuit PBbx is connected to the first circuit device PBax by wire or wirelessly, and may include a second processor 270bx for outputting a light emitting diode control signal from the first circuit device PBax, in particular, based on a control signal from the first processor 270x, a memory 240y for storing data related to the light emitting diode control signal, a display driver 232x for outputting a light emitting diode driving signal based on the light emitting diode control signal, and a light emitting diode 230x for emitting light based on the light emitting diode driving signal.

According to the home appliance 200x related to the present disclosure, the core CREx of the first circuit device (PBax) operates, so that data related to firmware, load control or safety control, etc. are stored in the memory 240x of the first circuit device PBax, and the core CREx of the first circuit device PBax operates, so that system application, application related to operation mode, download application, etc. are stored in the memory 240x of the first circuit device PBax.

That is, according to the operation of the same core CREx of the first circuit device PBax, data related to firmware, load control or safety control, system applications, applications related to operation mode, download applications, etc. are all stored in the same memory 240x.

Meanwhile, when data update is required in the memory 240x, the same core CREx of the first circuit device PBax is configured to perform the operation mode control, so that an update according to the operation of the same core CREx of the first circuit device PBax must be performed, after the operation mode control is terminated. Therefore, there is a disadvantage in that it is difficult to perform an immediate update.

In addition, when some data in the memory 240x need to be updated, for example, when an application needs to be updated, there is a disadvantage in that all data stored in the memory 240x needs to be updated. Further, there is a disadvantage in that it is difficult to perform the upgrade of the new operation mode.

FIGS. 4B and 4C are diagrams for explaining FIG. 4A.

First, FIG. 4B illustrates that the server 500 transmits various data FDax, FDbx, FDcx to the home appliance 200x.

For example, among the various data FDax, FDbx, FDcx received from the server 500, a first data FDax may be firmware update information or load control update information, a second data FDbx may be an application update information, and a third data FDcx may be display update information.

Next, FIG. 4C is a diagram illustrating movement path of various data FDax, FDbx, FDcx received in the home appliance 200x.

Referring to FIG. 4C, when the home appliance 200x receives first data FDax that is firmware update information or load control update information, the first data FDax may be stored in the memory 240x, via the transceiver 222x and the core CREx of the first processor 270x, according to a first path Pthax.

Meanwhile, when the home appliance 200x receives second data FDbx which is application update information, the second data FDbx may be stored in the memory 240x, via the transceiver 222x and the core CREx of the first processor 270x, according to a second path Pthbx.

Meanwhile, the core CREx of the first processor 270x may be configured to execute a firmware in an internal first area Ara, execute a firmware-based application in an internal second area Arb, and execute a firmware-based load control or safety control in an internal third area Arc.

Meanwhile, when the home appliance 200x receives the third data FDcx which is display update information, the third data FDcx may be stored in the memory 240y, via the transceiver 222x, the first processor 270x, and the second processor 270bx, according to a third path Pthcx.

As shown in the drawing, since the first data FDax that is firmware update information or load control update information and the second data FDbx that is application update information are all stored in the same memory, i.e., in the memory 240x, there is a disadvantage in that it is difficult to efficiently perform data update.

For example, when some data in the memory 240x need to be updated, in particular, when an application needs to be updated, there is a disadvantage in that all data stored in the memory 240x needs to be updated. Furthermore, there is a disadvantage in that it is difficult to upgrade the new operation mode.

Accordingly, the present disclosure suggests a method for efficiently performing the upgrade by separating the load control and the operation mode control. In addition, a method for efficiently performing firmware update or operation mode upgrade by separating the load control driven based on the firmware and the operation mode control executed based on the operating system is suggested. This will be described with reference to FIG. 5A and below.

FIG. 5A is an example of an internal block diagram of a home appliance according to an embodiment of the present disclosure.

Referring to FIG. 5A, the home appliance 200 according to an embodiment of the present disclosure includes a circuit device PBa having a first core CREa of a first processor 270 for load control or safety control, and a second core CREb that controls an operation mode based on the operating system 710, and is configured to perform an upgrade based on the upgrade information received from the external server 500 or the mobile terminal 600.

Specifically, when a hardware device is additionally mounted on the home appliance 200, the second core CREb of the first processor 270 may receive upgrade information related to a new operation mode using an additionally mounted hardware device from the external server 500 or the mobile terminal 600, and may be configured to perform an upgrade for the new operation mode based on the upgrade information related to the new operation mode.

For example, when the home appliance 200 is the washing machine 200a and an automatic detergent input device (not shown) is additionally mounted in the washing machine 200a, the second core CREb of the first processor 270 in the washing machine 200a may receive upgrade information related to a new washing machine operation mode in which an automatic detergent input mode is set in relation to the automatic detergent input device (not shown), and may be configured to perform an upgrade for the new washing machine operation mode based on the upgrade information related to the new washing machine operation mode.

As another example, when the home appliance 200 is the washing machine 200a, and a new sensor device (not shown) including a spectral sensor, an acceleration sensor, a gyro sensor, a turbidity sensor, and a humidity sensor is input to the washing machine 200a, the second core CREb of the first processor 270 in the washing machine 200a receives upgrade information related to a new washing machine operation mode operable based on various sensor information sensed by a sensor device (not shown), and may be configured to perform an upgrade for a new washing machine operation mode based on the upgrade information related to the new washing machine operation mode.

As another example, when the home appliance 200 is an air conditioner 200c, and a new sensor device (not shown) including a spectral sensor, an acceleration sensor, a gyro sensor, a dust sensor, a gas sensor, and a humidity sensor is disposed around the air conditioner 200c, the second core CREb of the first processor 270 in the air conditioner 200c may receive upgrade information related to a new air conditioner operation mode operable based on various sensor information sensed by a sensor device (not shown), and may be configured to perform an upgrade for the new air conditioner operation mode based on the upgrade information related to the new air conditioner operation mode.

Meanwhile, even if the home appliance 200 is not additionally equipped with a hardware device, when the upgrade information related to a new operation mode in software is received from the external server 500 or the mobile terminal 600, the second core CREb of the first processor 270 may be configured to perform an upgrade for the new operation mode based on the upgrade information related to the new operation mode.

For example, when the home appliance 200 is the refrigerator 200b and a new rapid cooling operation mode is generated in software, the second core CREb of the first processor 270 in the refrigerator 200b may receive upgrade information related to the new rapid cooling operation mode, and perform an upgrade for the new rapid cooling operation mode based on the upgrade information related to the new rapid cooling operation mode.

As another example, when the home appliance 200 is the cooking appliance 200d and a new rapid thawing operation mode is generated in software, the second core CREb of the first processor 270 in the cooking appliance 200d may receive upgrade information related to the new rapid thawing operation mode, and perform an upgrade for the new rapid thawing operation mode based on the upgrade information related to the new rapid thawing operation mode.

As another example, when the home appliance 200 is the cleaner 200e and a new motor speed variable operation mode is generated in software, the second core CREb of the first processor 270 in the cleaner 200e may receive upgrade information related to the new motor speed variable operation mode, and may be configured to perform an upgrade for the new motor speed variable operation mode based on the upgrade information related to the new motor speed variable operation mode.

Accordingly, the home appliance 200 according to an embodiment of the present disclosure may be called as an upgradable home appliance that can be upgraded to a new operation mode based on a change in hardware or software.

Meanwhile, the home appliance 200 according to an embodiment of the present disclosure may be configured to perform an update related to a setting change for an existing operation mode, in addition to an upgrade for a new operation mode.

In this specification, it is described that the upgrade of the operation mode means that a new operation mode is generated to be installed or executed, and the update of the operation mode means that setting or data change is performed for the existing operation mode.

Meanwhile, the home appliance 200 according to an embodiment of the present disclosure may further include a second circuit PBb having a second processor 270b for controlling the light emitting diode 230 or the display 280. Accordingly, the light emitting diode 230 or the display 280 can be controlled through a separate second circuit PBb.

Meanwhile, the first core CREa of the first processor 270 in the circuit device PBa may be configured to output a load control signal or a safety control signal to a load driver 245 that operates to drive a load such as a motor or a magnetron.

The load control signal may be divided into a main load control signal for controlling a load, which is a component having the largest power consumption, and a sub load control signal for controlling other components.

For example, the main load may be a washing machine motor in the case of the washing machine 200a, may be a compressor motor in the case of the refrigerator 200b and the air conditioner 200c, may be a magnetron or a light wave heater in the case of the cooking appliance 200d, and may be a fan motor in the case of the cleaner 200e.

Meanwhile, the sub-load may be a steam device or a fan motor in the case of the washing machine 200a, may be a fan motor or a defrost heater in the case of the refrigerator 200b and the air conditioner 200c, and may be a fan motor in the case of the cooking appliance 200d.

Meanwhile, the safety control signal may be a door lock control signal or a shutdown control signal for preventing overheating of motor, in the case of the washing machine 200a, may be a shutdown control signal for preventing overheating of motor, in the case of the refrigerator 200b and the air conditioner 200c, may be a shutdown control signal for preventing overheating of a magnetron or light wave heater, in the case of the cooking appliance 200d, and may be a shutdown control signal for preventing overheating of motor, in the case of the cleaner 200e.

Meanwhile, the first core CREa of the first processor 270 in the circuit device PBa may be configured to output a load control signal or a safety control signal, based on a control signal from the second core CREb of the first processor 270.

Meanwhile, the circuit device PBa includes a memory 240 that stores data related to the load control signal or the safety control signal.

Meanwhile, the first core CREa of the first processor 270 may be configured to output an inverter control signal or an inverter command signal for load control, particularly, for main load control. Accordingly, the load control or safety control can be directly or indirectly performed by using the first core CREa of the first processor 270 separated from the second core CREb of the first processor 270.

For example, when the home appliance 200 is the washing machine 200a, the first core CREa of the first processor 270 in the washing machine 200a may be configured to output an inverter control signal or an inverter speed command signal for rotation of the washing machine motor.

As another example, when the home appliance 200 is the refrigerator 200b, the first core CREa of the first processor 270 in the refrigerator 200b may be configured to output an inverter control signal or an inverter speed command signal for rotation of the compressor motor.

As another example, when the home appliance 200 is the air conditioner 200c, the first core CREa of the first processor 270 in the air conditioner 200c may be configured to output an inverter control signal or an inverter speed command signal for rotation of the compressor motor.

As another example, when the home appliance 200 is the cooking appliance 200d, the first core CREa of the first processor 270 in the cooking appliance 200d may be configured to output an inverter control signal for controlling a magnetron or a light wave heater.

Meanwhile, a sensor device 285 including a temperature sensor and a current sensor may transmit current information to the load driver 245 or the circuit device PBa, and transmit temperature information or the like to the circuit device PBa.

Accordingly, the first core CREa of the first processor 270 in the circuit device PBa may be configured to perform load control r safety control based on current information or the like, and the first core CREa of the first processor 270 in the circuit device PBa may generate an operation mode control signal based on temperature information or the like.

Meanwhile, the sensor device 285 may further include a camera or the like, an image signal from the camera or the like may be transmitted to the circuit device PBa, and the circuit device PBa may generate an operation mode control signal based on the image signal from the camera or the like.

Meanwhile, the sensor device 285 is a separate device provided with a plurality of sensors, and may include a spectral sensor, an acceleration sensor, a gyro sensor, a turbidity sensor, and a humidity sensor, and signals sensed by the plurality of sensors may be transmitted to the circuit device PBa, and the second core CREb of the first processor 270 in the circuit device PBa may generate an operation mode control signal based on the plurality of sensing signals.

Meanwhile, the sensor device 285 is a separate device provided with a plurality of sensors, and may include a spectral sensor, an acceleration sensor, a gyro sensor, a dust sensor, a gas sensor, and a humidity sensor, signals sensed by the plurality of sensors may be transmitted to the circuit device PBa, and the second core CREb of the first processor 270 in the circuit device PBa may generate an operation mode control signal based on a plurality of sensing signals.

Meanwhile, the second circuit PBb is connected to the circuit device PBa by wire or wirelessly, and may include a second processor 270b that outputs a light emitting diode control signal, based on a control signal from the circuit device PBa, in particular, from the second core CREb of the first processor 270, a memory 240b for storing data related to the light emitting diode control signal, a display driver 232 for outputting a light emitting diode driving signal based on the light emitting diode control signal, and a light emitting diode 230 which emits light based on the light emitting diode driving signal.

The circuit device PBa may include a second core CREb of the first processor 270 configured to perform an operation mode control, based on the operating system 710 of the home appliance 200, a memory 240 for storing data for the operating system 710 and the operation mode control, a transceiver 222 for performing communication with the external mobile terminal 600 or server 500, an audio output device 25 for outputting audio, an audio input device 252 for collecting audio, and an interface 260 for inter-processor communication (IOC) with the second circuit PBb or the like.

According to the home appliance 200 of FIG. 5A, data related to firmware, load control, or safety control is stored in the memory 240 of the circuit device PBa, depending on the operation of the first core CREa of the first processor 270, and an operating system OS, a system application, an application related to an operation mode, a download application, and the like are stored in the memory 240 of the circuit device PBa, depending on the operation of the second core CREb of the first processor 270.

That is, unlike FIG. 4A, data related to firmware, load control or safety control is stored depending on the operation of the first core CREa of the first processor 270, and an operating system OS, a system application, an application related to an operation mode, a download application, and the like are separately stored depending on the operation of the second core CREb of the first processor 270.

That is, based on the update information received through the transceiver 222 performing wireless communication with the mobile terminal 600, the update of data related to load control or safety control, and the update of the operating system OS, system application, application related to an operation modes, and download application can be separately performed.

Accordingly, the upgrade Of the operation mode can be efficiently performed by separating the load control and the operation mode control. Specifically, the update of firmware or the upgrade of operation mode can be efficiently performed by separating the load control driven based on the firmware and the operation mode control executed based on the operating system 710. In particular, an update related to the operation mode can be easily and efficiently performed. In addition, the operating system 710 executed in the second core CREb of the first processor 270 may be updated.

For example, when an application in the memory 240 needs to be updated, only a corresponding application among data stored in the memory 240 can be updated, thereby efficiently performing an update.

Meanwhile, unlike FIG. 4A, since the second core CREb of the first processor 270 in the circuit device PBa operates as a main processor of the home appliance 200, while operating based on the operating system OS rather than on the firmware, there is an advantage in that the operating system (OS)-based processing speed is considerably faster than the firmware-based processing.

Meanwhile, it is preferable that the processing speed of the second core CREb of the first processor 270 is faster than that of the first processor 270 or the second processor 270b. Accordingly, the operation mode control executed based on the operating system 710 can be efficiently performed.

Meanwhile, the circuit device PBa or the second circuit PBb may be configured to perform a remote procedure call communication with the circuit PBa which is an example of inter-processor communication IPC.

That is, the second core CREb of the first processor 270 in the circuit device PBa may be configured to perform a remote procedure call communication with the circuit device PBa which is an example of inter-processor communication (IPC) with the second processor 270b of the second circuit PBb. Thus, an efficient communication can be performed by using inter-processor communication (IPC).

Meanwhile, it is preferable that the memory 240 of the circuit device PBa in FIG. 5A has a larger storage space than the storage space of the memory 240b of the second circuit PBb.

Accordingly, among the update information received from the transceiver 222, update information to be transmitted to the memory 240b of the second circuit PBb, not to the memory 240 of the circuit device PBa can be temporarily stored by the memory 240 of the circuit device PBa, and then transmitted to the memory 240b of the second circuit PBb. Accordingly, the update can be efficiently performed.

FIG. 5B is another example of an internal block diagram of a home appliance according to an embodiment of the present disclosure.

Referring to FIG. 5B, a home appliance 200b according to an embodiment of the present disclosure is similar to the home appliance 200 of FIG. 5A, but there is a difference in that a separate display 280 is further provided in addition to the light emitting diode 230.

The separate display 280 may be an LCD display, an OLED display, or the like.

In the following, only a difference from FIG. 5A is described.

The second processor 270b of the second circuit PBb may operate to control the light emitting diode 230 or the display 280.

For example, the second processor 270b may be configured to output a light emitting diode control signal, based on a control signal from the second core CREb of the first processor 270, and the display driver 232 may be configured to output a light emitting diode driving signal to the light emitting diode 230, based on the light emitting diode control signal.

Meanwhile, the display 280 may be driven, based on a display control signal output from the second core CREb of the first processor 270.

Meanwhile, unlike the drawing, the second processor 270b of the second circuit PBb may be configured to output a display control signal for controlling the display 280 to the display 280, based on a control signal from the second core CREb of the first processor 270.

Meanwhile, FIGS. 5A and 5B illustrate one memory 240 of the circuit device PBa, but, unlike this, it is also possible to separately provide a first memory for the first core CREa of the first processor 270 and a second memory for the second core CREb of the first processor 270.

FIG. 5C is another example of an internal block diagram of a home appliance according to an embodiment of the present disclosure.

Referring to FIG. 5C, a home appliance 200c according to an embodiment of the present disclosure is similar to the home appliance 200 of FIG. 5A, but has a difference in that instead of a plurality of cores CREa and CREb of the first processor 270, a plurality of virtual machines VMa and VMb are executed of the first processor 270.

That is, the home appliance 200c according to the embodiment of the present disclosure includes a circuit device PBa having a first processor 270 that executes a first virtual machine VMa for load control or safety control, and the first processor 270 executes a second virtual machine VMb that controls an operation mode based on the operating system 710 separately from the first virtual machine VMa, and is configured to perform an upgrade based on upgrade information received from the external server 500 or the mobile terminal 600. Accordingly, load control and operation mode control are separated to efficiently perform an upgrade related to the operation mode. Specifically, load control driven based on firmware and operation mode control executed based on the operating system are separated to efficiently perform an operation mode upgrade. In addition, the operating system executed in the second virtual machine VMb of the first processor 270 can also be updated.

Meanwhile, the first virtual machine VMa executes load control or safety control based on the firmware, and the second virtual machine VMb controls the operation mode based on the operating system.

Meanwhile, the second virtual machine VMb may be configured to perform an application update during the operation mode based on application update information received from the external server 500 or the mobile terminal 600. Accordingly, the load control and the operation mode control may be separated to perform the update efficiently. In particular, the application update may be performed immediately.

Meanwhile, the first virtual machine VMa of the first processor 270 in the circuit device PBa may be configured to output a load control signal or a safety control signal to the load driver 245 that operates to drive a load such as a motor or magnetron.

Meanwhile, the first virtual machine VMa in the first processor 270 in the circuit device PBa may be configured to output a load control signal or a safety control signal, based on a control signal from the second virtual machine VMb in the first processor 270.

Meanwhile, the first virtual machine VMa in the first processor 270 may be configured to output an inverter control signal or an inverter command signal for load control, particularly, main load control. Accordingly, load control or safety control may be performed directly or indirectly, by using the first virtual machine VMa in the first processor 270 separated from the second virtual machine VMb in the first processor 270.

Meanwhile, the first virtual machine VMa of the first processor 270 in the circuit device PBa may be configured to perform load control or safety control, based on current information, etc., and the first virtual machine VMa of the first processor 270 in the circuit device PBa may generate an operation mode control signal, based on temperature information, etc.

Meanwhile, the second virtual machine VMb in the first processor 270 may be configured to execute an operating system, execute a framework on the operating system, and execute a system application, an application related to the operation mode, or a download application on the framework. Accordingly, it is possible to perform update of the framework, application, or the like, based on the operating system simply and efficiently.

Meanwhile, in response to the home appliance being a first product, the second virtual machine VMb of the first processor 270 may be configured to execute an operating system, execute a common framework on a part of the operating system, execute a first product framework on another part of the operating system, and execute a first product-related application on the common framework and the first product framework. Accordingly, the first product may be operated based on a common platform.

Meanwhile, in response to the home appliance being a second product, the second virtual machine VMb of the first processor 270 may be configured to execute an operating system, execute a common framework on a part of the operating system, execute a second product framework on another part of the operating system, and execute a second product-related application on the common framework and the second product framework. Accordingly, the second product may be operated based on a common platform.

Meanwhile, the second virtual machine VMb of the first f processor 270 may be configured to update the first product-related application while the first product is in operation. Accordingly, the update of the first product-related application may be performed immediately.

Meanwhile, the second virtual machine VMb of the first processor 270 may be configured to update the operating system or the common framework, after the operation of the first product is terminated. Accordingly, the update of the operating system or the common framework of the first product can be performed stably.

Meanwhile, it is preferable that the processing speed of the second virtual machine VMb in the first processor 270 is faster than the processing speed of the first virtual machine VMa in the first processor 270. Accordingly, the operation mode control executed based on the operating system can be efficiently performed.

FIG. 5D is another example of an internal block diagram of a home appliance according to an embodiment of the present disclosure.

Referring to FIG. 5D, the home appliance 200d according to an embodiment of the present disclosure is similar to the home appliance 200c of FIG. 5C, but has a difference in that a separate display device 280 is additionally provided in addition to the light-emitting diode 230.

The separate display device 280 may be an LCD display, an OLED display, etc.

Meanwhile, FIGS. 5C and 5D illustrate one memory 240 of the circuit device PBa, but unlike this, a first memory for the first virtual machine VMa of the first processor 270 and a second memory for the second virtual machine VMb of the first processor 270 may be provided separately.

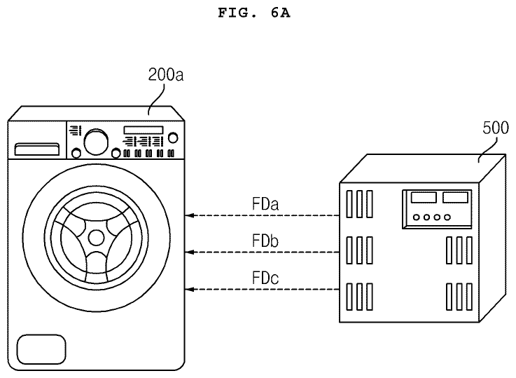

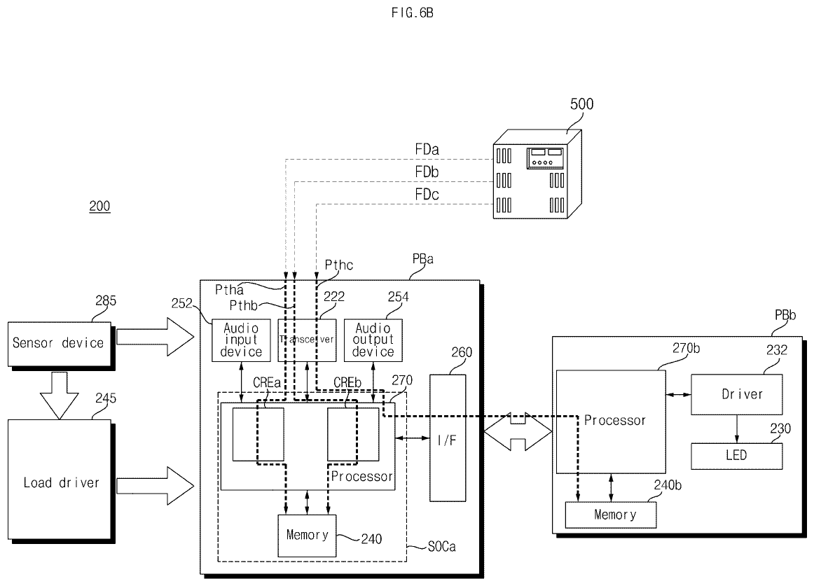

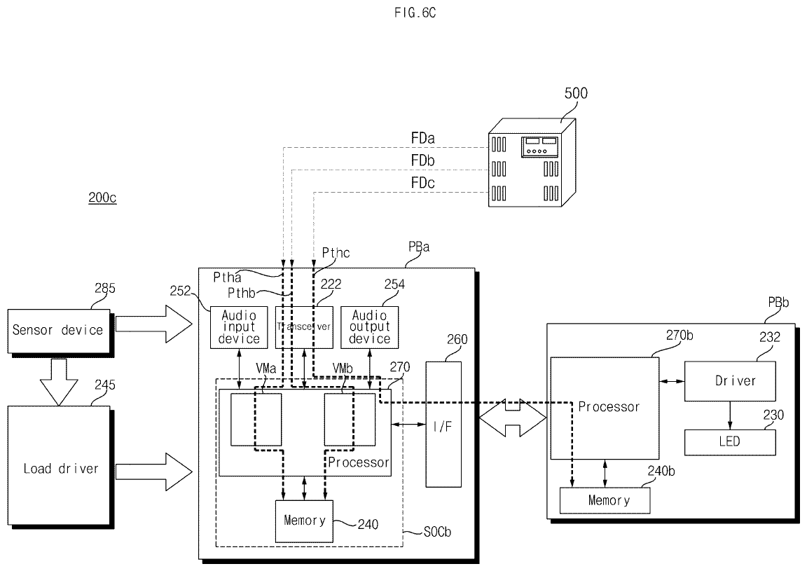

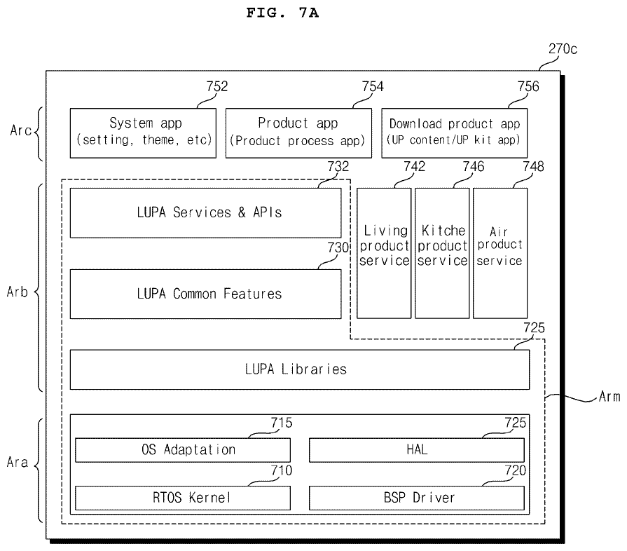

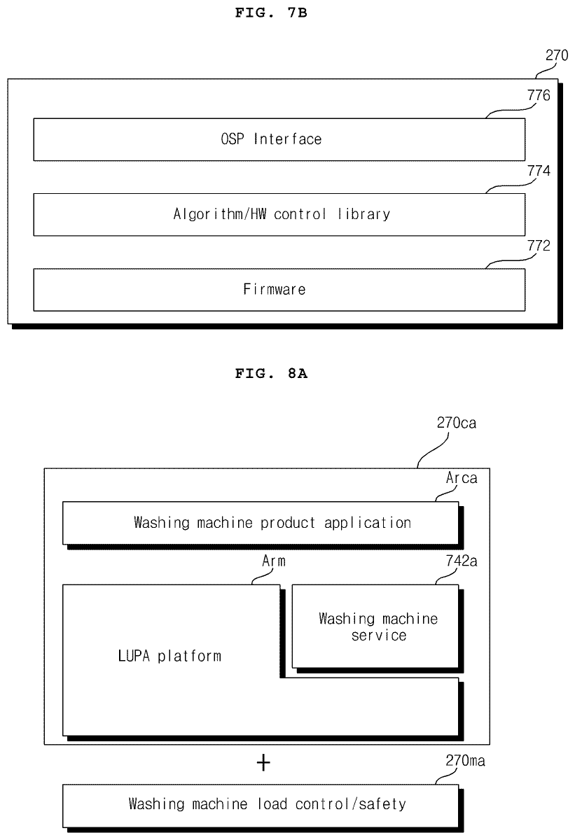

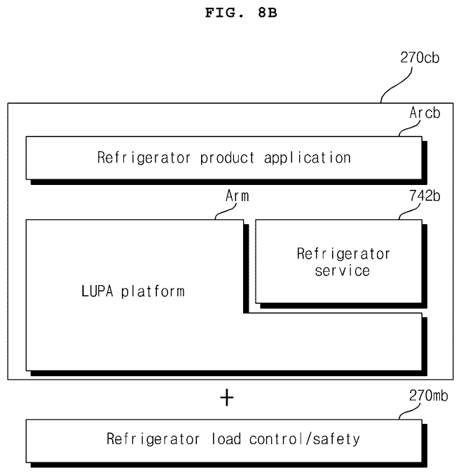

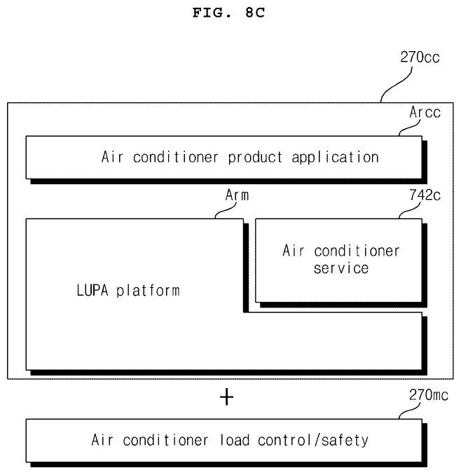

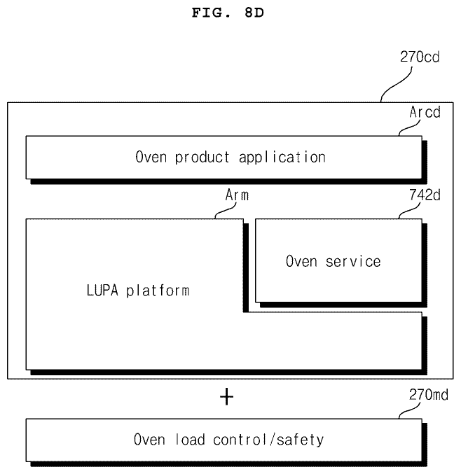

FIGS. 6A to 10D are diagrams for explaining the operation of the home appliance of FIG. 5A or 5B.

First, FIG. 6A illustrates that the server 500 transmits various data FDax, FDbx, FDc to the home appliance 200.

For example, among the various data FDax, FDbx, FDc received from the server 500, a first data FDa may be firmware update information or load control update information, and a second data FDb may be an application update information, and a third data FDc may be display update information.

Next, FIG. 6B is a diagram illustrating movement path of various data FDax, FDbx, FDc received by the home appliance 200 of FIG. 5A.

Referring to the drawing, when the home appliance 200 receives first data FDa that is firmware update information or load control update information, the first data FDa may be stored in the memory 240 Of circuit device PBa, via the transceiver 222 of the circuit device PBa and the first core CREa of the first processor 270, according to a first path Ptha.

Meanwhile, the first processor 270 of the circuit device PBa may be configured to execute the firmware in the internal first core CREa, and execute the firmware-based load control or safety control in the internal first core CREa.

Meanwhile, when the home appliance 200 receives the second data FDb as application update information, the second data FDb may be stored in the memory 240 Of the circuit device PBa, via the transceiver 222 of the circuit device PBa and the second core CREb of the first processor 270, according to a second path Pthb.

Similarly, when the home appliance 200 receives the operating system update information or the framework update information, the operating system update information or the framework update information may be stored in the memory 240 of the circuit device PBa, via the transceiver 222 of the circuit device PBa and the second core CREb of the first processor 270, according to the second path Pthb.

Meanwhile, when the home appliance 200 receives the third data FDc that is display update information, the third data FDc may be stored in the memory 240y of the second circuit PBb, via the transceiver of the circuit device PBa, the second core CREb of the first processor 270, and the second processor 270b of the second circuit PBb, according to a third path Pthc 222.

As shown in the drawing, the first data FDa, which is firmware update information or load control update information, is stored in the memory 240 of the circuit device PBa, and the application update information is separately stored in the memory 240 of the circuit device PBa, according to the operation of the second core CREb of the first processor 270, so that data update can be performed efficiently.

In particular, the update of data stored in the memory 240 of the circuit device PBa can be performed efficiently and frequently.

For example, when an application of the memory 240 needs to be updated, only the application area in the memory 240 of the circuit device PBa, not the entire memory 240x of FIG. 4C, can be selectively updated, so that update can be performed efficiently.

In addition, the application may be updated during the operation mode of the home appliance 200, by separately storing application data in the memory 240 of the circuit device PBa. Accordingly, the application update can be performed immediately.

Meanwhile, the firmware for load control or safety control is stored in a partial area of the memory 240 in the circuit device PBa, the firmware for display control is stored in a partial area Fmb of the memory 240b in the second circuit PBb, and the operating system 710 and the like are stored in another area of the memory 240 in the circuit device PBa, thereby efficiently performing firmware update or operation mode upgrade by separating the load control driven based on the firmware and the operation mode control executed based on the operating system 710.

Next, FIG. 6C is a diagram illustrating the movement path of various data FDax, FDBx, FDC received by the home appliance 200c of FIG. 5C.

Referring to FIG. 6C, when the home appliance 200c receives a first data FDa which is firmware update information or load control update information, the first data FDa may be stored in the memory 240 of the circuit device PBa, via the transceiver 222 of the circuit device PBa and a first virtual machine VMa of the first processor 270, according to a first path Ptha.

Meanwhile, the first processor 270 of the circuit device PBa may be configured to execute firmware in the internal first virtual machine VMa, and execute firmware-based load control or safety control in the internal first virtual machine VMa.

Meanwhile, when the home appliance 200c receives a second data FDb which is application update information, the second data FDb may be stored in the memory 240 of the circuit device PBa, via the transceiver 222 of the circuit device PBa and the second virtual machine VMb of the first processor 270, according to a second path Pthb.

Similarly, when the home appliance 200c receives the operating system update information or the framework update information, the operating system update information or the framework update information may be stored in the memory 240 of the circuit device PBa, via the transceiver 222 of the circuit device PBa and the second virtual machine VMb of the first processor 270, according to the second path Pthb.

Meanwhile, when the home appliance 200c receives a third data FDc which is display update information, the third data FDc may be stored in the memory 240y in the second circuit device PBb, via the transceiver 222 of the circuit device PBa, the second virtual machine VMb of the first processor 270, and the second processor 270b of the second circuit device PBb, according to a third path Pthc.

As shown in the drawing, the first data FDa, which is firmware update information or load control update information, is stored in the memory 240 Of the circuit device PBa according to the operation of the first virtual machine VMa of the first processor 270, and the application update information is separately stored in the memory 240 of the circuit device PBa, according to the operation of the second virtual machine VMb of the first processor 270, thereby accomplishing efficient data update.

In particular, the update of the data stored in the memory 240 of the circuit device PBa can be performed efficiently and frequently.

For example, when an update of an application of the memory 240 is required, instead of updating the entire memory 240x of FIG. 4C, only the application area of the memory 240 of the circuit device PBa can be selectively updated, thereby accomplishing efficient update.

In addition, the application can be updated during the operation mode of the home appliance 200c by separately storing application data in the memory 240 of the circuit device PBa. Accordingly, the application update can be performed immediately.

Meanwhile, firmware for load control or safety control is stored in a partial area of the memory 240 of the circuit device PBa, firmware for display control is stored in a partial area of the memory 240b of the second circuit device PBb, and an operating system 710 or the like is stored in another area of the memory 240 of the circuit device PBa, so that the firmware update or the operation mode upgrade can be performed efficiently by separating the load control driven based on the firmware and the operation mode control executed based on the operating system 710.

FIG. 7A is a diagram illustrating a platform architecture executed in the second core CREb of the first processor 270 within the circuit device PBa.

Referring to FIG. 7A, the platform executed in the second core CREb of the first processor 270 within the circuit device PBa may be divided into a board support package layer Ara, a framework layer Arb on the board support package layer Ara, and an application layer Arc on the framework layer Arb.

The board support package layer (Ara) may include a Real Time Operating System (RTOS) kernel 710, an Operating System Adaptation layer 715 executed in the Real Time Operating System kernel 710, a board support package driver 720, and a hardware abstraction layer 722.

The framework layer (Arb) may include an upgradable platform library 725, a common feature layer 730 on the upgradeable platform library 725, a service on the common feature layer 730 and an application program interface (API) layer 732, a living product service framework 742, a kitchen product framework 746, and an air product framework 748.

Here, the living product service framework 742 may include a washing machine framework, a dryer framework, a clothing manager framework, and the like.

Meanwhile, the kitchen product framework 746 may include a cooking appliance framework, a water purifier framework, and the like.

The application layer Arc may include a system application 752 that is executed on the framework layer Arb, an application 754 related to an operation mode, or a download application 756.

As shown in the drawing, the second core CREb of the first processor 270 may be configured to execute the operating system 710, execute a framework Arb on the operating system 710, and may be configured to execute a system application 752, an application 754 related to the operation mode, or a download application 756 on the framework Arb. Accordingly, the update of the framework Arb or the application can be performed easily and efficiently based on the operating system 710.

Meanwhile, in an embodiment of the present disclosure, a common platform Arm applicable to various home appliances is suggested.

The operating system 710 and a part 725, 730, 732 of the framework Arb may correspond to the common platform Arm. Specifically, the operating system 710 may be commonly executed by other types of home appliances 200. Accordingly, various types of home appliances 200 can be operated based on the common platform. In addition, an update or upgrade can be efficiently performed by applying a common platform to the home appliance 200.

Meanwhile, other part 742, 746, 748 of the framework Arb, the system application 752, the application 754 related to the operation mode, and the download application 756 may correspond to a variable platform. Accordingly, the update of the variable platform or the upgrade of the operation mode can be efficiently performed.

As shown in FIG. 7A, the entire board support package layer Ara including the real-time operating system kernel 710, and a part, among the framework layer Arb, excluding the living product service framework 742, the kitchen product framework 746, and the air product framework 748 may be set as a common platform Arm applicable to various home appliances.

Accordingly, various types of home appliances 200 can be operated based on the common platform Arm. In addition, the update can be efficiently performed by applying the common platform Arm to the home appliance 200.

FIG. 7B is a diagram illustrating a platform architecture executed in the first processor 270 of the circuit device PBa.

Referring to FIG. 7B, the first processor 270 of the circuit device PBa may be configured to execute an interface 776 for communication with the third presser 270c, a firmware 772, and a library 774, which is executed on the firmware 772, for load control or operation mode control.

Thus, the update of the firmware or the upgrade of the operation mode can be efficiently performed by separating the load control driven based on the firmware and the operation mode control executed based on the operating system.

FIGS. 8A to 8D are diagrams illustrating a platform architecture in various home appliances.

FIG. 8A shows the platform architecture of the washing machine.

Referring to FIG. 8A, a second processor 270ca in the washing machine 200a may be configured to execute a common platform Arm including an operating system and a framework, a washing machine service framework 742a, and a washing machine-related application Arca on the common platform Arm.

Meanwhile, a first processor 270ma of the washing machine 200a may be configured to execute washing machine load control or washing machine safety control on firmware.

FIG. 8B shows the platform architecture of the refrigerator.

Referring to FIG. 8B, a second processor 270cb of the refrigerator 200b may be configured to execute a common platform Arm including an operating system and a framework, a refrigerator service framework 742b, and a refrigerator related application Arcb on the common platform Arm.

Meanwhile, a first processor 270mb in the refrigerator 200b may be configured to execute refrigerator load control or refrigerator safety control on firmware.

FIG. 8C shows a platform architecture of the air conditioner.

Referring to FIG. 8C, a second processor 270cc of the air conditioner 200c may be configured to execute a common platform Arm including an operating system and framework, an air conditioner service framework 742c, and an air conditioner related application Arcc on the common platform Arm.

Meanwhile, a first processor 270mc of the air conditioner 200c may be configured to execute air conditioner load control or air conditioner safety control on the firmware.

FIG. 8D shows a platform architecture of a cooking appliance.

Referring to FIG. 8D, a second processor 270cd of the cooking appliance 200d may be configured to execute a common platform Arm including an operating system and a framework, a cooking appliance service framework 742d, and a cooking appliance-related application Arcd on the common platform Arm.

Meanwhile, a first processor 270md of the cooking appliance 200d may be configured to execute the cooking appliance load control or the cooking appliance safety control on the firmware.

Referring to FIGS. 8A to 8D, since various types of home appliances 200 can be operated based on a common platform Arm, the update can be efficiently performed. In addition, the upgrade of the operation mode can be performed efficiently by separating the load control and the operation mode control.

FIG. 9A is a diagram for dividing a software update area and a firmware update area among platform executed in the second core CREb and the first core CREa of the first processor 270.

Referring to FIG. 9A, the platform executed in the second core CREb of the first processor 270 within the circuit device PBa may be divided into a board support package layer Ara including an operating system, a framework layer Arb on the board support package layer Ara, and an application layer Arc on the framework layer Arb.

In the second core CREb of the first processor 270, an area where software over-the-air (SOTA) is possible may be the application layer Arc, and an area Arn where firmware over the air (FOTA) is possible may be the board support package layer Ara and the framework layer Arb.

Meanwhile, in the first core CREa of the first processor 270 within the circuit device PBa, there is no area where software update is possible, and the area Arp where the firmware update is possible may be an area including all of an interface 776 for communication with the second core CREb of the first processor 270, the firmware 772, and the library 774.

As shown in FIG. 9A, the software update can be performed more efficiently and frequently by separating the software update area and the firmware update area.

Examples of the software update may be an update of a laundry process application, an enhanced dehydration application, an automatic detergent input application, a sound source theme application, a background theme application, and the like.

The software update may be an update based on a user's selection using the mobile terminal 600 or an update provided by a manufacturer.

Meanwhile, it is preferable that the firmware update is performed intermittently in comparison with a software update, and may be, for example, an operating system update, a framework update, a firmware update, a load control algorithm update, a safety control algorithm update, and the like.

Meanwhile, the operating system 710 or the framework Arb may be updated based on the firmware update information received from the server 500 or the mobile terminal 600, and the system application 752, the application 754 related to the operation mode, or the download application 756 may be updated based on the firmware update information or software update information received from the server 500 or the mobile terminal 600. Thus, the update or upgrade can be efficiently performed by separating the firmware update and the software update.

Meanwhile, the second core CREb in the first processor 270 may be configured to perform the update of the operating system 710 and the firmware update of the circuit device PBa independently. Accordingly, the update of the operating system 710 and the update of the firmware of the circuit device PBa can be efficiently performed.

Meanwhile, when the update data of the operating system 710 and the update data of firmware of the circuit device PBa are received, the firmware of the circuit device PBa may be updated, after the operating system 710 is updated. Thus, the update of the firmware of the circuit device PBa can be performed stably and efficiently by performing the update of the operating system 710 first.

Meanwhile, the circuit device PBa or the second circuit PBb may be updated, based on the firmware update information received from the server 500 or the mobile terminal 600, and the circuit device PBa may be updated based on the firmware update information or software update information received from the server 500 or the mobile terminal 600. Thus, the update of firmware or the upgrade of operation mode can be performed efficiently by separating the load control driven based on the firmware and the operation mode control executed based on the operating system 710.

Meanwhile, when the transceiver 222 receives the firmware update information from the server 500 or the mobile terminal 600, the second core CREb of the first processor 270 may be configured to transmit the firmware update information to the memory 240 of the circuit device PBa, and the memory 240 of the circuit device PBa may be configured to update the firmware based on the firmware update information. Accordingly, the firmware update can be efficiently performed.

Meanwhile, the memory 240 of the circuit device PBa may be configured to not update the firmware during the operation mode, but update firmware after the operation mode is terminated. Accordingly, the firmware update can be stably performed.

Meanwhile, when the transceiver 222 receives the software update information from the server 500 or the mobile terminal 600, the second core CREb of the first processor 270 may be configured to transmit the software update information to the memory 240 of the circuit device PBa, and the memory 240 of the circuit device PBa may be configured to update the application, based on the software update information. Accordingly, the software update can be efficiently performed.

Meanwhile, the memory 240 of the circuit device PBa may be configured to update application excluding the operating system 710 and the framework Arb among software, during the operation mode. Accordingly, the application update can be performed immediately.

Meanwhile, the memory 240 of the circuit device PBa may not upgrade a new operation mode during the operation mode, and may upgrade the new operation mode after the operation mode is terminated. Accordingly, the new operation mode can be upgraded stably.

Meanwhile, the memory 240 of the circuit device PBa may not update the operating system 710 or the framework Arb during the operation mode, but may be configured to update the operating system 710 or the framework Arb after the operation mode is terminated. Accordingly, the update of the operating system 710 or framework Arb can be performed stably.

FIG. 9B is a diagram illustrating a software update in the second core CREb in the first processor 270 of the washing machine 200a.

Referring to FIG. 9B, the second core CREb in the first processor 270 of the washing machine 200a may be configured to execute upgradable platform library 725 of a common platform that includes an operating system, a common functional layer 730 on the upgradeable platform library 725, a washing machine service framework 742a on the common functional layer 730, and a plurality of washing machine-related applications APa, APb, APC on the washing machine service framework 742a.

In order to update the first washing machine-related application 1 among the first to third washing machine-related applications APa, APb, APc, application update information is received from the server 500 or the like.

In this case, the application update information may be a fourth washing machine-related application APm for replacing a first washing machine-related application APa.

Accordingly, instead of the first washing machine-related application APa, the fourth washing machine-related application APm can be easily replaced and executed.

Meanwhile, the second core CREb in the first processor 270 according to the present disclosure is configured to perform super-loop dependency separation for blocking for each function, and is configured to perform an event-driven inter-processor communication to minimize processor occupancy.

Meanwhile, the second core CREb in the first processor 270 according to the present disclosure may communicate with the first processor 270 or the second processor 270b based on a variable packet method.

Meanwhile, the processor 270 may periodically transmit sensor data sensed by the load driver 245 or the like to the second core CREb in the first processor 270 through the inter-processor communication.

In this case, it is preferable that the first processor 270 transmits the sensor data to the second core CREb in the first processor 270 through the inter-processor communication, only when there is a change in the sensor data by a certain value or more.

In addition, the first processor 270 may compress and serialize the sensor data instead of raw data, and transmit it to the second core CREb in the first processor 270.

Accordingly, the second core CREb in the first processor 270 minimizes communication between the first processor 270 or the second processor 270b, thereby enabling efficient operation.

Specifically, the second core CREb in the first processor 270 may be configured to perform a remote procedure call communication which is an example of inter-processor communication, rather than a low-speed communication such as UART or SPI in which high-speed communication is difficult due to noise or interference, thereby enabling high-speed communication.

FIG. 9C is a diagram illustrating a software update interval and a firmware update interval.

Referring to FIG. 9C, it is preferable that a reception interval of the software update information received from the server 500 or the mobile terminal 600 is shorter than a reception interval of the firmware update information.

That is, the software update interval may be GPb between T1 and T2, and the firmware update interval may be GPa, between T0 and T4, greater than GPb. Accordingly, the software update can be performed frequently and simply.

Meanwhile, it is preferable that the update interval GPb of the second core CREb in the first processor 270 within the circuit device PBa is shorter than the update interval GPa of the first core CREa in the first processor 270 within the circuit device PBa or the update interval of 44 the second circuit PBb. Accordingly, the update of the second core CREb in the first processor 270 within the circuit device PBa can be performed frequently and efficiently.

Meanwhile, when the home appliance 200 is a first product, for example, a washing machine 200a, the second core CREb in the first processor 270 executes the operating system 710, execute the common framework Arb in a part on the operating system 710, execute the first product framework 742a, which is a washing machine service framework, in another part on the operating system 710, and execute a first product-related application, for example, a washing machine-related application, on the common framework Arb and the first product framework 742a.

Meanwhile, when the home appliance 200 is a second product, i.e., the air conditioner 200c, the second core CREb in the first processor 270 may be configured to execute the operating system 710, execute the common framework Arb in a part on the operating system 710, execute the second product framework 742c which is an air conditioner service framework in another part on the operating system 710, and may be configured to execute an application related to a second product, for example, to an air conditioner on the common framework Arb and the second product framework 742c. Accordingly, the washing machine 200a and the air conditioner 200c can be operated based on a common platform.

Meanwhile, the second core CREb in the first processor 270 may be configured to update the first product-related application during operation of the first product, and update the operating system 710 or the common framework Arb, after the operation of the first product is terminated.

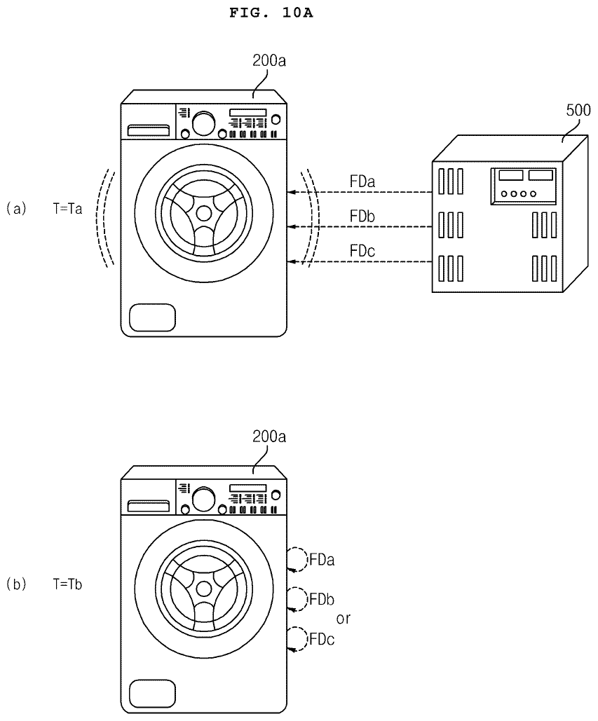

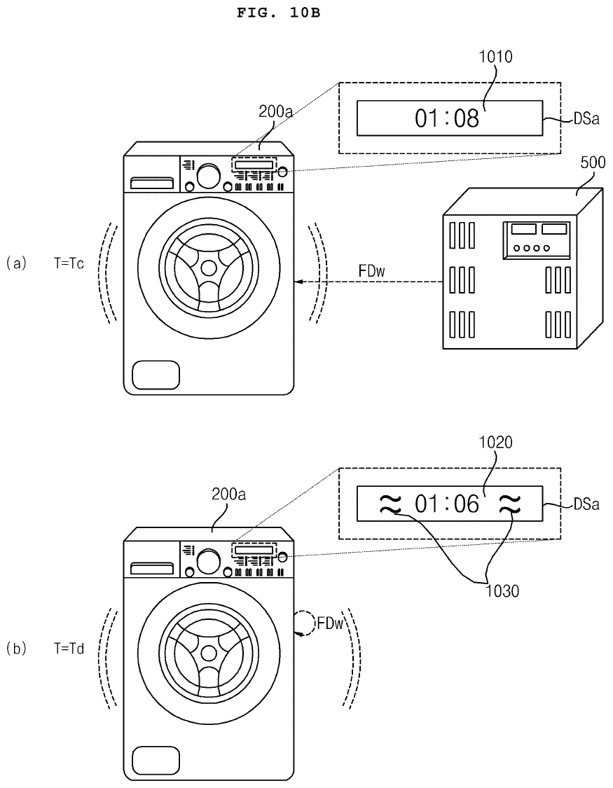

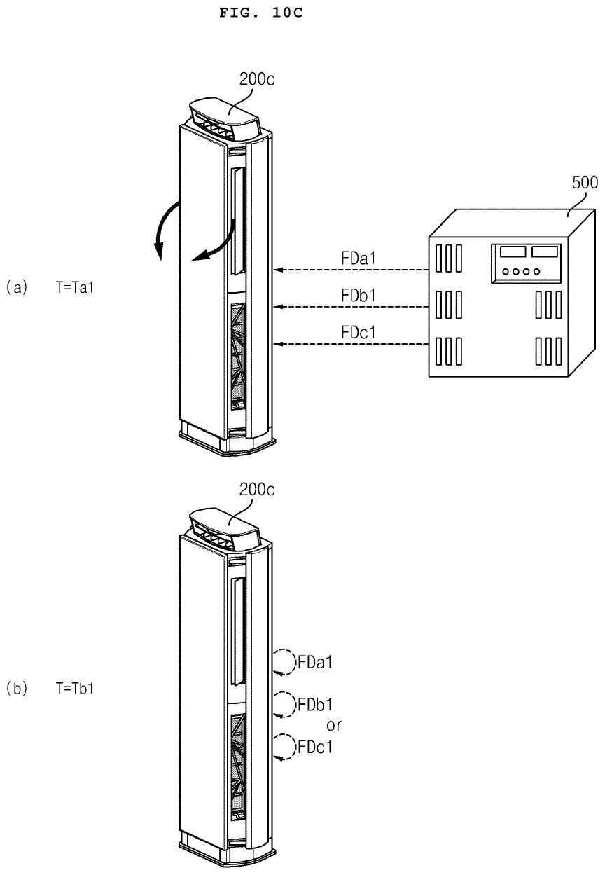

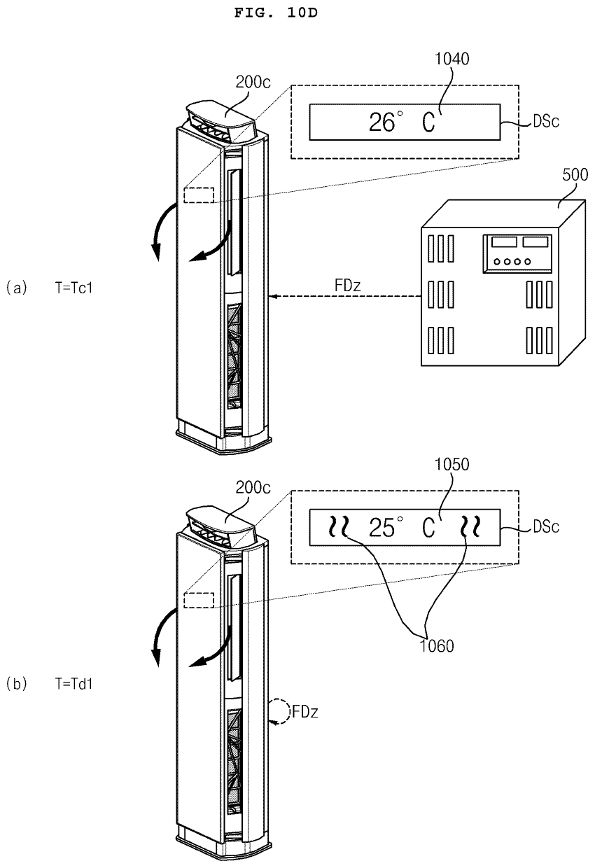

Specifically, the second core CREb in the first processor 270 may be configured to update a washing machine-related application during operation of the washing machine 200a, and update the operating system 710 or the common framework Arb after the operation of the washing machine 200a is terminated. Accordingly, the update of the washing machine-related application can be performed immediately, thereby stably updating the operating system 710 or the framework Arb. This will be described with reference to FIGS. 10A to 10D.

FIG. 10A is a diagram illustrating firmware update in the washing machine 200a.

Referring to FIG. 10A, at a first time point Ta when the washing machine 200a is operating, a first data FDa that is firmware update information or load control update information, a second data FDb that is operating system update information, or a third data FDc that is display update information from the server 500.

Since the firmware update information or load control update information, the operating system update information, the display update information, etc are, as described above, firmware over the air (FOTA)-based data, update cannot be performed during the operation of the washing machine 200a for safety reasons, and it is preferable to perform the update after the operation of the washing machine 200a is completed.

Accordingly, at a second time point Tb after the operation mode of the washing machine 200a is terminated, update may be performed based on the first data FDa that is firmware update information or load control update information, the second data FDb that is operating system update information, or the third data FDc that is the display update information.

For example, at the second time point Tb, the memory 240 in the circuit device PBa of the washing machine 200a can be updated, based on the first data FDa that is the firmware update information or the load control update information.

As another example, at the second time point Tb, the memory 240 in the circuit device PBa of the washing machine 200a may be updated, based on the second data FDb that is operating system update information.

As another example, at the second time point Tb, the third processor 27b in the second circuit PBb of the washing machine 200a may be updated, based on the third data FDc that is display update information.

FIG. 10B is a diagram illustrating a software update in the washing machine 200a.

Referring to FIG. 10B, at a third time point Tc when the washing machine 200a is operating, a fourth data FDw that is application update information related to the washing machine may be received from the server 500.

For example, the fourth data FDw that is washing machine-related application update information may be screen theme application update information.

As described above, since the washing machine-related application update information and the like are data that can be updated through software over-the-air (SOTA), an update can be performed immediately during operation of the washing machine 200a.

Accordingly, at a fourth time point Td when the washing machine 200a is operating, the fourth data FDw-based update, which is application update information related to the washing machine, may be performed.

In the drawing, it is illustrated that, at the third time point To, the screen theme of the display DSa of the washing machine 200a is a first theme 1010, and it is illustrated that, at the fourth time point Td at which the update is performed, the screen theme of the display DSa of the washing machine 200a is a second theme 1020.

The first theme 1010 includes only washing machine remaining operation time information, but the second theme 1020 may further include a background theme 1030, in addition to the washing machine remaining operation time information. Accordingly, the convenience of use of the washing machine 200a can be increased.

FIG. 10C is a diagram illustrating firmware update in the air conditioner 200c.

Referring to FIG. 10C, at a first time point Ta1 when the air conditioner 200c is operating, a first data FDa1 that is firmware update information or load control update information, a second data FDb1 that is operating system update information, or a third data FDc1 that is display update information may be received from the server 500.

Since the firmware update information or load control update information, the operating system update information, the display update information, etc., as described above, are firmware over the air (FOTA)-based data, the update cannot be performed during the operation of the air conditioner 200c for safety, etc., and it is preferable to perform the update after the operation of the air conditioner 200c is completed.

Accordingly, at a second time point Tb1 after the operation mode of the air conditioner 200c is terminated, an update based on the first data FDa1 that is firmware update information or load control update information, the second data FDb1 that is the operating system update information, or the third data FDc1 that is display update information may be performed.

For example, at the second time point Tb1, the memory 240 in the circuit device PBa of the air conditioner 200c can be updated, based on the first data FDa1 that is the firmware update information or the load control update information.

As another example, at the second time point Tb1, the memory 240 in the circuit device PBa of the air conditioner 200c may be updated, based on the second data FDb1 that is operating system update information.

As another example, at the second time point Tb1, the third processor 27b in the second circuit PBb of the air conditioner 200c may be updated, based on the third data FDc1 that is display update information.

FIG. 10D is a diagram illustrating a software update in the air conditioner 200c.

Referring to FIG. 10D, at a third time point Tc1 when the air conditioner 200c is operating, a fourth data FDz that is air conditioner-related application update information may be received from the server 500.

For example, the fourth data FDz that is air conditioner-related application update information may be screen theme application update information.

As described above, the air conditioner-related application update information and the like are data that can be updated through software over-the-air (SOTA), and thus can be updated immediately during the operation of the air conditioner 200c.

Accordingly, fourth time point Td1 when the air conditioner 200c is operating, an update based on the fourth data FDz, which is air conditioner-related application update information, may be performed.

In the drawing, it is illustrated that, at the third time point Tc1, the screen theme of the display DSc of the air conditioner 200a is a first theme 1040, and it is illustrated that, at the fourth time point Td1 at which the update is performed, the screen theme of the display DSc of the air conditioner 200a is a second theme 1050.

The first theme 1040 includes only current indoor temperature information, but the second theme 1050 may further include a background theme 1060, in addition to the current indoor temperature information. Accordingly, the convenience of use of the air conditioner 200c can be increased.

Meanwhile, referring to FIGS. 10A to 10D, the home appliance 200 according to another embodiment of the present disclosure includes a circuit device PBa having a first core CREa of a processor 270 for load control or safety control, and a second core CREb of the processor 270 that controls the operation mode based on the operating system 710, and is configured to perform an application update during an operation mode based on application update information received through the transceiver 222 for performing wireless communication with the external server 500 or the mobile terminal 600.

Accordingly, the upgrade of the operation mode can be performed efficiently by separating the load control and the operation mode control. In particular, an application update can be performed immediately.

Meanwhile, the home appliance 200 according to another embodiment of the present disclosure may further include a second circuit PBb having a second processor 270b for controlling a light-emitting diode 230 or a display device 280.

Meanwhile, referring to FIG. 10B, when receiving the display theme related update information FDw from the server 500 or the mobile terminal 600, the second core CREb in the first processor 270 may be configured to display a first display theme 1010, and then to perform an update based on the display theme related update information FDw during operation mode, at a first time point Ta, and to display a second display theme 1020 corresponding to the display theme related update information FDw, at a second time point Tb after the first time point Ta. Accordingly, the display theme related update can be performed immediately.

Meanwhile, referring to FIGS. 10A to 10B, the second core CREb in the first processor 270 may be configured to execute the operating system 710, execute the framework Arb on the operating system 710, execute at least one application on the framework Arb, perform an update of at least one application based on the application update information FDw during operation mode, and update the operating system 710 or the framework Arb, based on the update information (FDa, FDb, or FDc) received from the server 500 or the mobile terminal 600, after the termination of the operation mode. Accordingly, it is possible to immediately perform an application update, and stably update the operating system 710 or the framework Arb.

Meanwhile, referring to FIG. 10A, after the termination of the operation mode, the second core CREb in the first processor 270 may be configured to update the circuit device PBa or the second circuit PBb, based on the firmware update information (FDa or FDc) received from the server 500 or the mobile terminal 600. Accordingly, the firmware update of the circuit device PBa or the second circuit PBb can be performed stably.

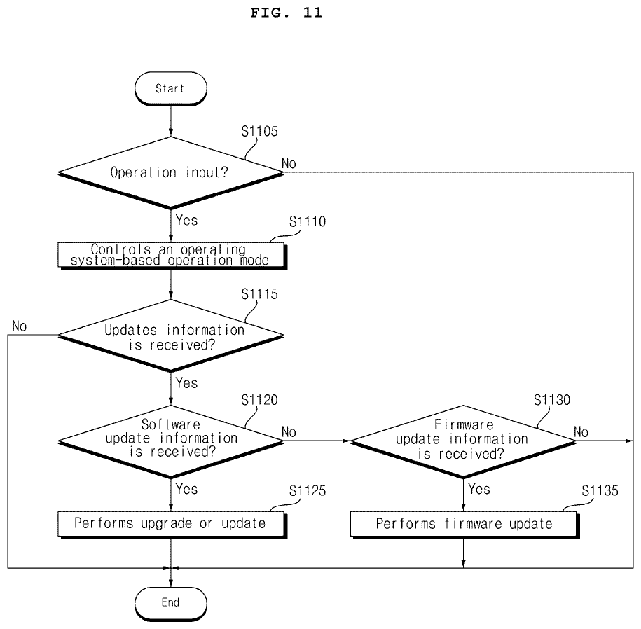

FIG. 11 is a flowchart illustrating a method of operating a home appliance according to an embodiment of the present disclosure.

Referring to FIG. 11, in a standby mode, when there is an operation input corresponding to the operation of a physical handling key or an operation input by remote control (S1105), the home appliance 200 is configured to cancel the standby mode, and perform an operating system-based operation mode (S1110).

For example, in the case of the washing machine 200a, the washing operation mode may be performed after the power is turned on, based on a continuous operation of a power key and an operation key.

As another example, in the case of the refrigerator 200b or the air conditioner 200c, a freezing operation or a cooling operation may be performed based on the operation of a temperature setting key.

As another example, in the case of the cooking appliance 200d, a thawing operation mode or a heating operation mode may be performed based on an operation of an operation key.

Next, during the operation mode, when update information is received (S1115), the second core CREb in the first processor 270 determines whether the received update information is software update information (S1120), and if applicable, can perform upgrade or update (S1125).

For example, when the received software update information is update information on a new operation mode, the second core CREb in the first processor 270 may be configured to perform upgrade based on update information for the new operation mode, after the termination of the operation mode.

Specifically, the second core CREb in the first processor 270 may be configured to perform the upgrade by storing the update information on a new operation mode in the memory 240, after the termination of the operation mode.

As another example, when the received software update information is information on an application, the second core CRED in the first processor 270 may directly update the application, during the operation mode.

Meanwhile, when the received update information is not software update information at step 1120 (S1120), the second core CREb in the first processor 270 determines whether the received update information is firmware update information (S1130).

Further, when the received update information is firmware update information, the second core CREb in the first processor 270 is configured to perform a firmware update (S1135).

For example, when the received firmware update information is information on the operating system or the framework, the operating system or the framework may be updated after the termination of the operation mode.

As another example, when the received firmware update information is firmware update information on load control or display, the memory 240 of the circuit device PBa or the memory 240b of the second circuit PBb may be updated.

Accordingly, the update or upgrade based on the software update information can be efficiently performed, and the firmware update based on the firmware update information can be stably performed.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

What is claimed is:

1. A home appliance comprising:
a circuit device including a first processor,
wherein the first processor comprises a first core for load control or safety control, and a second core configured to control an operation mode based on an operating system, and perform an upgrade based on upgrade information received from an external server or a mobile terminal.

2. The home appliance of claim 1, further comprising a second circuit including a second processor configured to control a light emitting diode or a display.

3. The home appliance of claim 1, wherein the second core of the first processor is configured to execute the operating system, execute a framework on the operating system, and execute a system application, an application related to the operation mode, or a download application on the framework.

4. The home appliance of claim 3, wherein a part of the framework and the operating system correspond to a common platform.

5. The home appliance of claim 1, wherein update information is received from the external server or the mobile terminal, and
wherein a reception interval of software update information received from the server or the mobile terminal is shorter than a reception interval of firmware update information received from the server or the mobile terminal.

6. The home appliance of claim 1, wherein the second core of the first processor is configured to perform an update based on update information received from the external server or the mobile terminal, and
wherein a software update interval of the circuit device is shorter than a firmware update interval of the circuit device.

7. The home appliance of claim 1, wherein the circuit device is updated based on firmware update information received from the server or the mobile terminal, and
wherein the circuit device is updated based on the firmware update information or software update information received from the server or the mobile terminal.

8. The home appliance of claim 2, wherein the circuit device is configured to perform a remote procedure call communication with the second circuit.

9. The home appliance of claim 1, wherein the circuit device further comprises a transceiver configured to perform wireless communication with the server or the mobile terminal.

10. The home appliance of claim 1, wherein the circuit device further comprises a memory configured to store firmware for load control or safety control in a first area, and store the operating system in a second area.

11. The home appliance of claim 10, wherein when firmware update information is received from the server or the mobile terminal,
wherein the second core of the first processor is configured to transmit the firmware update information to the memory of the circuit device, and
wherein the memory in the circuit device is configured to update the firmware based on the firmware update information.

12. The home appliance of claim 11, wherein the memory in the circuit device is configured to not update the firmware during the operation mode, and update the firmware after the operation mode is terminated.

13. The home appliance of claim 10, wherein in response to software update information being received from the server or the mobile terminal,
the second core of the first processor is configured to transmit the software update information to the memory of the circuit device, and
the memory of the circuit device is configured to perform a software update based on the software update information.

14. The home appliance of claim 1, wherein in response to the home appliance being a first product, the second core of the first processor is configured to execute an operating system, execute a common framework in a part on the operating system, execute a first product framework in another part on the operating system, and execute a first product-related application on the common framework and the first product framework.

15. The home appliance of claim 1, wherein in response to the home appliance being a second product, the second core of the first processor is configured to execute the operating system, execute a common framework in a part on the operating system, execute a second product framework in another part on the operating system, and execute a second product-related application on the common framework and the second product framework.

16. The home appliance of claim 14, wherein the second core of the first processor is configured to update the first product-related application, during operation of the first product.

17. A home appliance comprising;
a circuit device including a first processor,
wherein the first processor comprises a first core for load control or safety control, and a second core configured to control an operation mode based on an operating system, and perform application update during the operation mode based on application update information received from an external server or a mobile terminal.

18. The home appliance of claim 17, wherein when firmware update information is received from the server or the mobile terminal, the second core of the first processor is configured to perform a firmware update, after the operation mode is terminated.

19. A home appliance comprising a circuit device including a processor configured to execute a first virtual machine for load control safety control,
wherein the processor is further configured to execute a second virtual machine to control an operation mode based on an operating system, and perform an upgrade based on upgrade information received from an external server or a mobile terminal.

20. The home appliance of claim 19, wherein the first virtual machine is configured to execute the load control or safety control based on firmware, and
wherein the second virtual machine is configured to control the operation mode based on the operating system, and perform an application update during the operation mode based on application update information received from the external server or mobile terminal.
